(19) United States
(12) Patent Application Publication
(10) Pub. No.: US 2026/0363271 A1
(43) Pub. Date: Nov. 19, 2026

(54) Extrudate retarders, extruder configured to carry out high-moisture protein texturization extrusion, flow bender, improvement to high-moisture protein texturization extrusion method, method of performing extrusion with an extruder having a cooling die, method of manufacturing meat replacement products using high-moisture protein texturization extrusion, and method of increasing manufacturing capacity of meat replacement production where high-moisture protein texturization extrusion is used

(71) Applicant: Valio Oy, Helsinki (FI)

(72) Inventors: Jingwei LIU, Helsinki (FI); Zhongqing JIANG, Helsinki (FI)

(21) Appl. No.: 19/153,804

(22) PCT Filed: Feb. 7, 2024
(86) PCT No.: PCT/EP2024/053068

§ 371 Date: Aug. 5, 2025

(30) Foreign Application Priority Data
Feb. 7, 2023 (FI) 20235117

(51) Int. Cl. A23J 3/26; A23J 3/14; A23J 3/22; B29C 48/40; B29C 48/70

(52) U.S. Cl. CPC A23J 3/26; A23J 3/14; A23J 3/227; B29C 48/40; B29C 48/70

(57) ABSTRACT

To increase the controllability of the method of manufacturing meat replacement products using high-moisture protein texturization extrusion, aa flow (F) of melt extrudate having a gel-like substance and exiting an extruder barrel (85) is treated in an extrudate retarder (2) comprising a flow conduit (C) and located immediately after the extruder barrel (85), the flow conduit (C) having directional turns and a narrowing cross-section, such that the directional turns and the narrowing cross-section are selected so that the storage modulus of the melt extrudate flow (F) in the extrudate retarder (2) is utilized to prevent extrudate blow-outs or melt extrudate from uncontrolledly escaping from the extruder barrel (85). So extrudate blow-outs may be reduced or avoided. Further, extrudate quality may be improved. There is a number of parallel independent claims.

### FIELD OF THE INVENTION

The invention relates, on one hand, to extruder equipment and implements, and, on the other hand, to their use and to high-moisture protein texturization extrusion, in particular in the manufacture of meat replacement products.

### BACKGROUND ART

Food and animal feeds are nowadays frequently manufactured by extrusion. This includes wet texturing, in which fibrous structures are formed. It can be carried out to manufacture mostly carbohydrate-rich foods or animal feeds or protein-rich foods or animal feeds. The latter is referred to as protein texturization extrusion. It can be carried out using plant-based proteins, animal-based proteins, or a combination of both.

In recent years, many people have turned vegetarian or vegan, or at least increased the share of vegetables and vegetable products in their diet. While ecological concerns are the reason for some, it appears also clear that vegetables and products made of vegetables should be a central part of a healthy diet. Many consumers find it difficult to ensure a daily protein intake with vegetables or products made of vegetables, while some find it time-consuming to prepare the protein-containing ingredients for cooking or baking.

Thus, there is a market for vegetarian or vegan foods produced on an industrial basis by extrusion cooking. Extrusion cooking is a continuous process which enables the production of texturized proteins that are unique products made by extrusion. The extrusion enables controlling the functional properties such as density, rate and time of rehydration, shape, product appearance and mouthfeel.

For extrusion of meat replacement products, also known as meat analogues or texturized vegetable products, a twin screw extruder is normally used. There are mainly two types of extrusion cooking methods for preparing meat replacement products.

One kind of meat replacement products is produced with low moisture protein texturization extrusion. Such products have a moisture content between 10% and 40% (moisture content during extrusion is between 15% and 40%). They often have a sponge-like texture and require rehydration prior consumption. These products are often used as minced meat substitutes or extenders in meat products but can hardly mimic fibrous whole-muscle meat.

Another kind of meat replacement products is manufactured with high moisture protein texturization extrusion, preferably with a twin-screw extruder having a long cooling die (the cooling die having a length of at least 300 mm, preferably of at least 800 mm, most preferably of at least 1000 mm, up to, 5000 mm, preferably). Such products have a moisture content between 40% and 80%. The moisture content during extrusion is between 40%-80%. They generally resemble more muscle food than the meat replacement products manufactured with low moisture texturization extrusion. There is a sequence of temperature controlling zones along with the extruder barrel during protein texturization extrusion. One of those zones has a temperature higher than the other zones, which can be regarded as the peak extrusion temperature. The peak extrusion temperature of high-moisture protein texturization extrusion is commonly between 100-220 °C, preferably between 120 and 200 °C, more preferably between 140 and 190 °C. The peak extrusion temperature is chosen as the temperature that can melt, crosslink and texturize the extruded proteinaceous matrix forming ingredients.

In high-moisture protein texturization extrusion, proteinaceous ingredients that are mixed with water to form a slurry which is fed into the extruder. The extruder operates at sufficiently high temperature and pressure to melt the proteins, and also kneads and mixes the ingredients. The material exiting the extruder barrel is referred to as “melt extrudate”.

In the context of meat replacement products manufacturing using high-moisture protein texturization extrusion, which are generally manufactured by mixing at least one proteinaceous matrix forming ingredient, such as at least one kind of protein isolate and/or at least one kind of protein concentrate (that generally are referred to as protein fractions), possibly starch-containing particles (such as, flour, bran, treated grains etc.), possibly oil and spices, and water to form a slurry, and extruding the slurry in an extruder that is configured to carry out protein texturization extrusion. Also in the contents of meat replacement products, the material exiting the extruder barrel is referred to as melt extrudate. It may contain inclusions, grains, etc. that are not melted. The proteins, however, are melt.

As explained in the introductory part of European patent application of Bühler AG published under publication number EP3524009A1, fibrous texture is not always easy to achieve, because an extrudate typically expands at the outlet of the extruder, which is detrimental to a dense, compact, fibrous product structure. In this patent application publication, an extruder distributor is disclosed. The patent application publication discloses that with the extruder distributor, extrudates with different kinds of textures may be obtained by suitably selecting which kinds of apertures are placed between the extruder and the cooling die.

### Objective of the Invention

The unique combination of extrusion temperature (such as, and in particular the peak extrusion temperature), extrusion moisture content, ingredient composition, extruder long cooling die configuration and extruder screw profile makes high-moisture protein texturization extrusion significantly different from the typical low-moisture protein texturization extrusion.

The higher moisture content and required heating energy for texturizing proteins make the high-moisture protein texturization extrusion to cause the extruded mass to have less viscosity and more vaporization power (vapour emanating from the extrudate), which makes it challenging to achieve a high level of extrusion stability. The higher moisture content makes the extrusion-shear-induced energy input less effective in the high-moisture protein texturization extrusion than in the low-moisture protein texturization extrusion. The higher moisture content makes it difficult to have a long retention time in the extruder since the melt extrudate tends to escape from the extrusion system (extruder barrel and/or cooling die) too fast. For these reasons, the extruder screw configuration and die assembly configurations for high-moisture protein texturization extrusion are generally different from those for other types of extrusions. High-moisture protein texturization extrusion is as a process less stable and less predictable than low-moisture protein texturization extrusion.

A first objective of the invention is to improve the quality of extrudates and enable increasing production capacity of an extruder configured to carry out high-moisture protein texturization extrusion. This objective can be met with the extrudate retarder according to any one of the independent claim 1, 5, 14, or 20, each referring to a different aspect of an extrudate retarder, or any combinations of any two of the aspects that is formulated by combining any two independent extrudate retarder claims (claims 1+5, 1+14, 1+20; 5+14, 5+20; 14+20), or any combination of any three of the aspects that is formulated by combining any three independent claims (claims 1+5+14, 1+5+20, 5+14+20), or with a combination of all four of the aspects that is formulated by combining all four independent claims (claims 1+5+14+20).

A further objective of the invention is to improve the extrusion quality or the production capacity (extrusion power) of an extruder configured to carry out high moisture protein texturization extrusion. This objective may be met with the extruder configured to carry out high-moisture protein texturization according to claim 33.

A still further objective of the invention is to improve the quality of high-moisture protein texturization extrusion. This objective can be met with the improvement according to claim 36.

And a further objective of the invention is to improve method of performing extrusion with an extruder having a cooling die, the extruder and cooling die preferably configured to carry out high-moisture protein texturization extrusion. This objective can be met with the method according to claim 37.

A still further objective of the invention is to improve the controllability of the method of manufacturing meat replacement products using high-moisture protein texturization extrusion, or to increase quality of the extrudates. This objective can be met with the method according to independent claim 38.

A still further objective of the invention is to increase the manufacturing capacity of meat replacement production where high-moisture protein texturization is used. This objective can be met with the method according to independent claim 39.

A still further objective of the invention is to enable reducing extrudate blowouts (extruder shooting). This objective can be met with a flow bender according to independent claim 52.

The dependent claims describe advantageous aspects of the extrudate retarder, of the extruder, the flow bender, and of the methods.

### Advantages of the Invention

An extrudate retarder-more particularly suitable for high-moisture protein texturization extrusion-comprises a) an inlet end as inlet for receiving a flow of melt extrudate from an extruder, b) an outlet end as outlet for the flow of melt extrudate to a cooling die, and c) a flow conduit suitable for flow of melt extrudate and in flow connection between the inlet end and outlet end. The melt extrudate is in the envisaged usage situations a melt protein mass that exits the extruder barrel after protein texturization extrusion which preferably is high-moisture protein texturization extrusion (moisture content of the extruded protein mass during extrusion is between 40%-80%). Such a protein mass comprises, in addition to the extrudate, also vapor (which normally may be superheated vapor) which is preferably retained in the extrudate.

According to a first aspect of the invention, the flow conduit extends through a flow bender located between the inlet end and the outlet end. The flow bender is configured to receive a flow of melt extrudate and having a flow conduit that has an essentially circular cross-section and to change the flow in the downstream to the flow direction to centrifugal flow or substantially radially outwards directed flow to an essentially ring-like cross-section that is larger than the circular cross section such that the flow continues through a first aperture (31) arranged in an aperture frame that is plate-like or slab-like, such as plate or slab, to have separated streams of melt extrudate along the ring-like cross section, which in particular is a circular ring section, where the section comprises at least 300°, preferably at least 325°, particularly preferably comprises at least 350°, and then further downstream in the flow direction to turn the flow to a centripetal flow or substantially radially inwards directed flow to join the separated streams to a uniform flow having an essentially circular cross-section. The joining is carried out through another aperture arranged in an aperture plate.

Between turning from substantially radially outwards directed flow to substantially radially inwards directed flow or from centrifugal to centripetal flow the flow passes through the first aperture once.

In this manner, the retaining time of the melt extrudate in the extruder barrel may be increased. Further, and especially in the context of high-moisture protein texturization extrusion, the quality of extrudates may be improved and extrudate blow-outs may be better avoided. Without be willing to be bound by theory, the first aspect of the extrudate retarder which is the change in the cross-section of the flow conduit may effect a back-and-forth movement the flow of melt extrudate, following the shape of the flow conduit walls, following the aperture treatment. This is believed to cause a sort of kneading that may cause the result.

With “substantially radially outwards directed flow” and “substantially radially inwards directed flow” we mean the main flow direction. Though the flow may be turbulent at times, there being eddy currents and other flow characteristics, the main flow of the extrudate is from inlet end to outlet end. This is illustrated in FIG. 5 with the arrow F which has been labeled as “flow of melt extrudate”. Given the is at least some degree of symmetry present (such as, circular cross sections in the channels and a ring-like cross section around the main axis shown in FIG. 5 with the dash-dot-line, the “flow of melt extrudate” can be imagined to be rotated around the symmetry axis in case of rotational symmetry.

The configuration of the flow bender is advantageously chosen such that the flow of melt extrudate is in heat transfer connection with the flow bender from opposite sides of the flow bender. As one example to achieve this purpose, the flow bender may be designed to have a moderate thickness such that the distance between the inlet fitting and the aperture plate, is between 10 and 100 mm, preferably between 20 and 50 mm, and more preferably between 30 and 40 mm. Alternatively or in addition, the aperture thickness (which is the distance between the entrance and exit of each aperture) may be limited to be between 4 and 60 mm, preferably between 10 and 30 mm, and more preferably between 15 and 22 mm.

In this manner, the time for the melt extrudate between entering the extruder (e.g. extruder barrel) and exiting the extruder (e.g. extruder barrel) may be prolonged while essentially maintaining the temperature of the melt extrudate until entering a cooling die. This is believed to be relate to an observed improvement in the quality of extrudate. More specifically, for example, the extrudate has more intact surface, better air-cavity-induced expansion, and more homogenous appearance (along with different locations of the extrudate, and between different producing times). With the prolonged time, the cooking of the ingredients may be improved. In addition, in this manner, the time for the melt extrudate between exiting the extruder and entering a cooling die may be prolonged while essentially maintaining the temperature of the melt extrudate. This is believed to be related to an observed improvement in the quality of extrudate.

The flow bender may comprise an inflow deflector and an outflow deflector that are on opposite faces of the flow bender, such that the first aperture has an essentially ring-like cross section which radially surrounds the inflow deflector and the outflow deflector but such that the first aperture has a thickness that is less than the combined maximum thickness of the thickness of flow bender measured at the position of the inflow deflector and the outflow deflector.

This facilitates transfer of heat from the melt extrudate at the inflow deflector to the flow bender. The flow bender enables heat transfer by conduction to the outflow deflector which transfers heat to the melt extrudate. In this manner, it may be more effective to essentially maintain the temperature of the melt extrudate at the extrudate retarder.

A synonym for “aperture” in the present description and claims is a breaker plate. An aperture contains a number of openings (orifices) and is typically an orifice plate/slab or perforated plate/slab. Its function is to separate a stream of melt extrudate to separated streams of melt extrudate, when the stream of melt extrudate passes the orifice/perforated plate/slab. The size, position and number of orifices/perforations in the aperture can vary.

When the melt extrudate mass passes through the aperture, the flowable space gets suddenly reduced during to the facts that flow channel cross-sectional area formed by the openings (orifices) in the aperture is smaller than the flow channel cross-sectional area before entering the aperture. The size of each opening or orifice is also relative small. So the aperture causes a high friction force and pressure, which increase the retention time of the melt extrudate mass inside the extruder, and increase the pressure inside the extruder. The aperture also has the function of making the melt extrudate mass relatively more homogenous and aligned into the same flow direction.

According to a second aspect of the invention, the flow conduit extends through a flow bender configured to turn the flow of melt extrudate through a U turn and/or an L turn arranged such that an aperture is located at the turn.

Preferably, the flow bender is configured to turn the flow of melt extrudate through a U turn and an L turn arranged such that an aperture is located at each turn.

In this manner, the retaining time of the melt extrudate in the extruder barrel may be increased particularly effectively by utilizing the viscosity of the melt extrudate to retard the extrudate flow. Further, and especially in the context of high-moisture protein texturization extrusion, the quality of extrudates may be improved and extrudate blow-outs may be better avoided. Without be willing to be bound by theory, the second aspect of the extrudate retarder which is the bend(s) in the flow conduit including an aperture at (each) bend may effect an increased kneading of the extrudate outside the extruder barrel in a manner which appears to be particularly well suitable for increasing the homogenous appearance of the extrudate along with different locations of the extrudate, and different producing time.

The flow bender may integrally comprise an outflow deflector or the outflow deflector may be detachable from the flow bender. While an integral outflow deflector may be more robust, the detachable outflow deflector may facilitate cleaning between production batches.

Further, the aperture in the flow bender may be integral to the flow bender or detachable.

The flow bender may advantageously be configured to cause the U turn by walls of the flow conduit limiting to the aperture, assisted by inflow deflector that preferably comprises a conical structure. This is a particularly simple structure that comprises no undercuts and so facilitates easy cleaning of the parts between production batches.

The flow bender may advantageously be configured to cause the L turn by an outflow deflector that comprises a conical structure. This is a particularly simple structure that comprises no undercuts and so facilitates easy cleaning of the parts between production batches.

According to a third aspect of the invention,
the inlet end is arranged in an inlet fitting configured to fit with an extrudate outlet of the extruder;
the outlet end is arranged as an outlet fitting configured to fit with an extrudate inlet of the cooling die;
extrudate retarder further comprising a stack of consecutive plate-like elements, including
   i) a flow bender comprising at least one plate-like or slab-like aperture that has a ring-shaped cross section, the flow bender further comprising an inflow deflector on its face against the direction of the flow for turning the flow to a centrifugal flow or substantially radially outwards directed flow, and an outflow deflector on the opposite face for turning a centripetal flow or substantially radially inwards directed flow to substantially 90 degrees in the direction of a rotational symmetry axis of the ring, and
   ii) an aperture plate comprising an aperture located in the direction of flow of melt extrudate downwards and comprising an aperture that has a circular cross-section.

The inventors have found that when the extrudate retarder is realized with a stack of plate-like elements, the retention time of the melt extrudate can be prolonged before the extrudate is cooled in the cooling die can be prolonged, while undesired cooling of the extrudate may be better avoided, especially if the plate-like elements are of steel which ensures that the thermal conduction between the plate-like elements is suitably high. Optionally, the alignment position of at least some of the consecutive plate-like elements (preferably at least the inlet fitting, more preferably in addition to the inlet fitting also the flow bender, and most preferably in addition to these also the sheathing element and the aperture plate) is assisted by a positioning member such as a stick/pin. In this situation, the respective plate-like elements comprise form-locking means such as a notch to engage with the positioning member.

The flow bender may be held in place between an inlet fitting and a sheathing element by a cover fastened to the extruder preferably via a bolt connection. This is a relatively simple though easily cleanable configuration that can be made mechanically stable.

The sheathing element may comprise a recess for receiving a funnel element. This facilitates the cleaning of the extrudate retarder between production batches. If the funnel could not be cleaned it can be replaced.

The funnel element, when in place, preferably lays flat with the aperture plate to prevent flow of melt extrudate from entering the space between the aperture plate and funnel element outside of the aperture and a tapering section forming the funnel. This facilitates cleaning of the extrudate retarder between production batches.

The extrudate retarder may comprise a sheathing element comprising a recess for receiving an aperture plate and having at least one shoulder to support the aperture plate. This is a particularly simple arrangement for holding the aperture plate in place and further for collecting the melt extrudate together from the aperture plate. This in particular, when the extrudate retarder comprises a funnel element comprising a tapering section that forms a funnel and which is placed in the recess of the sheathing element, and an aperture plate comprising at least one aperture resting on the at least one shoulder such that the at least one aperture overlaps with the funnel.

According to a fourth aspect of the invention, the extrudate retarder (which optionally may comprise the features a), b), c) described above) comprises a flow bender configured to divert the flow of melt extrudate around a number of bends, namely in particular U turn and L turn following each other in this order, where at each of the bends, an aperture is arranged for the flow to go through, and further an optional flow constrictor between a flow bender at least to partially cover the aperture. This enables an easy manner of implementing adjustability for the retarding effect.

The flow constrictor is preferably a blocking ring. This enables a relatively simple way to adjust the retarding effect of the extrudate retarder, such as, by selecting width of the blocking ring.

Alternatively, the flow constrictor may comprise a first blocking ring and a second blocking ring arranged on opposite sides of the flow bender, both partially blocking the aperture in the flow bender. This may facilitate the flow of the melt extrudate and ease the cleaning of the extrudate retarder after each production batch.

The blocking rings are preferably provided in a set, such that in the set, rings or pairs of rings have different blocking widths. This may ease adjustability of the blocking effect of the blocking rings, such as, if the extrudate retarder is to be utilized for melt extrudates having different viscosities between production batches.

The flow bender may comprise an outlet deflector that is formed integrally in the flow bender or arranged removably such that it can be replaced. The removable outlet deflector may facilitate easier cleaning of the extrudate retarder between production batches. The integrally formed outlet deflector may be more robust in prolonged use.

The flow bender may comprise an inlet deflector that is formed integrally in the flow bender or arranged removably such that it can be replaced. The removable inlet deflector may facilitate easier cleaning of the extrudate retarder between production batches. The integrally formed inlet deflector may be more robust in prolonged use.

The extrudate retarder may comprise a tapering section that is located in the flow direction downwards from an aperture plate, forming a funnel such that the cross-section of the flow channel gets narrower in the direction of the flow of melt extrudate.—This may homogenize the flow of extrudate in radial direction.

A straight section may follow in flow direction after the tapering section. This may let the melt extrudate settle before entering the cooling die.

Preferably, the inlet end has a shape defined by an inlet fitting configured to match an extrudate outlet of the extruder.

The inlet fitting may be exchangeable. This facilitates providing the extrudate retarder for different extruders, extruders of different size and possibly of different manufacturers. The inlet fitting preferably has a funnel-like tapering form that tapers from the inlet end in the flow direction to suit the opening in the bending plate.

The extrudate retarder may consist of stainless steel or at least the flow conduit may have walls limiting the flow conduit, all of which consist of or comprise stainless steel, such that the stainless steel features a high grade of food compatibility, preferably such that the stainless steel is in conformity to EN 10088 classification numbers 1.43xx or 1.44xx.

The flow conduit may have walls limiting the flow conduit, all of which have roughness in the range of R_{α} 1, 6 to R_{α} 0, 8 in accordance with DIN EN ISO 4287:1998.

With all of the four aspects described above, the prototype extrudate retarder that was tested in the applicant's laboratory and factory could be observed to improve the homogeneity of the extrudate, to improve the extrusion capacity, and to avoid extrudate blowouts, in particular, in protein texturization extrusion that is carried out as high moisture protein texturization extrusion i.e. moisture content of the extruded protein mass during extrusion is between 40%-80%. Without willing to be bound by theory, this is expected to at least partly result from the improved retention of the melt mass in the extruder barrel. The increase of the retention time of the extrudate at screws and extruder barrel of the extruder is believed to improve the extrusion capacity (in kg/h) because it increases the time and energy that the extruded materials are being sheared, kneaded and heated by the extruder screws. The prolonged shearing, kneading and heating make the extruded materials more cooked, texturized and cohesive. As results, the extrudate blowouts are better avoided; and the homogeneity of the extrudate is improved.

After exiting the extruder screws and extruder barrel, normally, the melt extrudate cools very fast and its viscosity increases. In contrast to the cited '009 patent application publication, the extrudate retarders according to the present invention are substantially uncooled. In order to increase the retention time, the melt extrudate must pass through the flow conduit of the flow bender which causes an advancing forth-and-back motion, preferably with apertures arranged in the U and L bends, so not only helping to prolong the time between exiting the extruder barrel and entering the cooling die while avoid unnecessary cooling to keep the extrudate viscosity substantially low, to substantially maintain good flowability and homogeneity of the melted extrudate and to save equipment footprint but further mixing and homogenizing the melt extrudate can be achieved.

Without the implementation of the extrudate retarder, in order to increase the retention time, it may otherwise be necessary to replace lost heat to heat the extrudate in order to keep the viscosity low enough. This may require the need to use an external energy source for heating the extrudate retarder and further it would require a larger equipment footprint in the production facility. In other words, the retention time can be prolonged in an energy-saving and footprint-saving time if the flow channel sections are arranged in the manner as described in the claim.

The inventors have observed that with this kind of extrudate retarder, extrudate blowouts may be better avoided in the context of high-moisture protein texturization extrusion. Without the extrudate retarder, extrudate blowouts occurred more frequently than with the extrudate retarder. The extrudate blowouts occur more frequently and severely during typical high-moisture protein texturization extrusion (without the extrudate retarder) than during typical low-moisture extrusion, because the higher moisture content during extrusion may result in higher water vaporization pressure (energy), lower extrudate viscosity, lower pressure at the end of the extruder die and lower pressure at the end of the extruder barrel. Without willing to be bound by theory, it is believed that the improved retention of substantially uncooled extrudate suits to have the extrudate to become “thoroughly cooked” and kneaded which then for some reason appears to reduce the risk of extrudate blowouts.

The inventors have further observed that, with the extrudate retarder, the extruder in the production facility they work on could be fed more starting ingredients per time unit than without the extrudate retarder, while the extruder is configured to carry out high-moisture protein texturization extrusion.

The result in preliminary tests has been that the extrusion capacity (in kg/h) with the extrudate retarder can be preferably 1,5-times, more preferably 4 times, the extrusion capacity without the extrudate retarder. Given the substantial cost of purchasing and operating an extruder (cost of purchasing and amortizing the extruder, cost of required footprint, cost of personnel and time to clean an extruder, cost of maintaining further production lines etc) this is a significant improvement in terms of feasibility of manufacturing food and feed by high moisture protein texturization extrusion.

An extruder according to the invention is configured to carry out high-moisture protein texturization extrusion-advantageously to manufacture meat-replacement products preferably having protein fibres mostly aligned to be in parallel with each other. For this purpose, the extruder contains a slurry inlet (if ready-mixed slurry is used) and/or water inlet (if other ingredients are fed into the extruder separately from water). The extruder further comprises a number (preferably two) extruder screws arranged in an extruder barrel, an extrudate retarder according to first, second, third or fourth aspect (or according to any two aspects or three aspects, or all four aspects), the inlet end of which is connected to an extrudate outlet of the extruder and the outlet end of which is connected to an extrudate inlet of a cooling die.

Preferably, extrudate retarder is connected to the extruder via a cover of the extrudate retarder with a number of bolt connections, the cover holding the flow bender in place. This ensures a tight (even a gas-tight) but still elastic connection.

The extrudate retarder preferably comprises an inlet fitting which has shape of extrudate outlet which is a twin-screw extruder outlet such that, when the extrudate retarder is connected to the extruder, a pressure-tight connection (i.e. pressure-tight for the normal operation pressure of the extruder) between extruder and the extrudate retarder is achieved to restrict the flow of the melt extrudate from the extruder via the flow conduit to outlet end and from there further to the cooling die.

Improvement to high-moisture protein texturization extrusion method—advantageously to manufacture meat-replacement products preferably having protein fibres mostly aligned to be in parallel with each other—is that the retention time of the extrudate at screws and extruder barrel of the extruder and the travel time from the extruder screws and extruder barrel to cooling die are prolonged using an extrudate retarder according to any one of the first, second, third and fourth aspect (or any combination of two or three of these, or all four aspects) such that the melt extrudate passes through a flow conduit of the extrudate retarder passing via the flow bender.

In the method of performing high-moisture protein texturization extrusion with an extruder having a cooling die—advantageously to manufacture meat-replacement products—preferably having protein fibres mostly aligned to be in parallel with each other, between an extrudate outlet of the extruder and an extrudate inlet of the cooling die, an extrudate retarder according to any one of the preceding claims may be used such that the melt extrudate passes through a flow conduit of the extrudate retarder and thereby goes through the flow bender.

Regarding all aspects and embodiments disclosed above, the cooling die is preferably a long cooling die, advantageously having a length between 1000 and 5000 mm. Such a long cooling die is particularly useful in high-moisture protein texturization extrusion of food or animal feed.

Further, regarding all aspects and embodiments disclosed above the extrusion and extruder are preferably configured to carry out high-moisture protein texturization of food or animal feed, especially of meat replacement products (meat imitates).

In a method of manufacturing meat replacement products—preferably having protein fibres mostly aligned to be in parallel with each other—using high-moisture protein texturization extrusion, a flow of melt extrudate having a gel-like substance and exiting an extruder barrel is treated in an extrudate retarder comprising a flow conduit and located immediately after the extruder barrel, the flow conduit having directional turns and a narrowing cross-section, such that the directional turns and the narrowing cross-section are selected so that the storage modulus of the melt extrudate flow in the extrudate retarder is utilized to prevent extrudate blow-outs or melt extrudate from uncontrolledly escaping from the extruder barrel. This increases the controllability of the method since extrudate blow-outs may be reduced or avoided. Further, extrudate quality may be improved.

In a method of increasing manufacturing capacity of meat replacement products—preferably having protein fibres mostly aligned to be in parallel with each other—production where high-moisture protein texturization extrusion is used, retention of extrudate at an extruder having an extruder barrel is improved with an extrudate retarder comprising a flow conduit and located immediately after extruder barrel, the flow conduit having directional turns and a narrowing cross-section, such that retention time of extrudate between entering the extruder and entering a cooling die is increased. The seemingly contradictory process of retarding the flow of extrudate has been observed by the inventors to increase the manufacturing capacity of meat replacement production where high-moisture protein texturization is used. In the preliminary tests by the applicant, an increase in the extrusion capacity (in kg/h) to 1,5 to 4 fold and even more could be achieved.

In the methods, the extruder described above is preferably used. The flow of melt extrudate may be passed through a first aperture having channels having a first cross section area, and then in the flow direction through an aperture having channels having a second cross section area, which is larger than the first cross section area. The first cross-section area may be in the range of 3.46 mm²-7.07 mm², and the second cross section area may be selected from the range of 7 mm²-17 mm² such that it is larger than the first cross-section area.

The ratio of total area of all channels of the aperture in flow bender to the area of extruder barrel cross section is preferably between 12% and 25%.

The ratio of total area of all channels at the aperture located in downstream to the flow bender to the area of extruder barrel cross section is preferably between 9% and 14%.

The extrusion is preferably carried out by feeding dry ingredients to the extruder, under addition of water or water-based liquid under conditions selected to produce a meat replacement product having protein fibres mostly aligned to be in parallel with each other using high-moisture protein texturization extrusion.

In the extrusion, as dry ingredients the following may be used: non-soy legume protein isolate and/or concentrate (such as: i) pea protein isolate and/or concentrate, ii) faba bean protein isolate and/or concentrate, or iii) a combination of i) and ii)) together with cereal ingredients—such as oat ingredients, preferably including one or more of the following: oat flour, oat bran, or steel-cut oat, or a combination of two or three of these.

In addition or alternatively, in the extrusion, the following can also be used as dry ingredients: soy protein isolate and/or concentrate, with or without cereal ingredients.

High moisture protein texturization extrusion using dry ingredient containing soy protein isolate and/or concentrate will be more easy to handle than using ingredients that use non-soy proteins like faba bean proteins and/or pea proteins, because soy protein can form homogenous protein matrix more easily than pea protein isolate and faba bean protein isolate do. In scientific publications, soy proteins often have been described to have a better solubility and gelling properties than pea protein and faba bean protein do. In extrusion for meat analogues, especially high-moisture protein texturization extrusion, soy proteins can be more easily controlled and processed than pea protein and faba bean proteins to form a fibrous and homogenous structure.

In the extrusion, when the non-soy legume protein contents weight ratio to the oat ingredient is below 2.5, the extrusion is harder to control and consequently the texturization will be harder to achieve. Without willing to be bound by theory, the present inventors believe that this may be because the lower protein content and higher carbohydrate content from the cereal ingredients alike oat ingredients will lower the extrudate viscosity at melt state inside the extruder and make less protein to contribute to building continuous phase and protein crosslinking matrix.

The extruder retarder or flow bender (preferably used with a further aperture plate containing a further aperture) may provide help to soy protein containing extrusion, but even more significant help it may provide to high-moisture protein texturization extrusion having protein fibres mostly aligned to be in parallel with each other using ingredients like non-soy legume protein isolate and/or concentrate (such as pea protein isolate and/or concentrate; and/or faba bean protein isolate and/or concentrate; or a combination of them) together with cereal ingredients (such as oat ingredients—such as oat flour, oat bran, or steel-cut oat, or a combination of two or three of these). With the extruder retarder or flow bender (preferably used with a further aperture plate containing a further aperture) such ingredients may be extruded under addition of water or water-based liquid under conditions selected to produce a meat replacement product. Salt, mineral (such as Calcium salt), oil and/or spices may be added.

The weight ratio of water or water-based liquid to dry ingredients may be 55% to 90%, preferably 58% to 87%, most preferably 59% to 85%.

The weight ratio of pea protein isolate and/or concentrate to oat ingredients may advantageously be between 1.5-3:1, preferably 1.7-2.5:1, most preferably essentially 1.86:1.

The moisture content during extrusion may be between 40% and 55%, preferably between 41% and 53%, most preferably between 43% and 51%.

A flow bender comprises a steel plate or steel slab forming an aperture frame having an integral inflow deflector and an integral aperture surrounding the inflow deflector and suitable for forming streams of melt extrudate from a stream of melt extrudate.

The flow bender may be used in an extruder retarder according to any one of the preceding aspects, in an extruder according to any one of the preceding aspects, or in a method or improvement according to any one of the preceding aspects, respectively.

The inflow deflector may comprise a conical structure.

The flow bender may further comprise an integrated outflow deflector that preferably comprises a conical structure.

The steel plate or steel slab may be essentially planar.

The flow bender is best used with a further aperture plate comprising an aperture, located in the flow direction downstream of the flow bender and containing an aperture.

The flow bender is then preferably with the further aperture plate, dimensioned so that orifices or openings in the first aperture are substantially not overlapping with orifices or openings in the further aperture, such that the flow bender with the apertures jointly implement a gas seal for water vapor contained in the extruded mass, most preferably located between extruder barrel and a first cooling die.

Although the flow bender is in the embodiments presented below described as part of an extrudate retarder that is attached after an extruder barrel outlet, the flow bender may be arranged (possibly together with an inlet fitting and preferably also with the further aperture plate with the further aperture) inside the extruder barrel before the extrudate outlet) in an extruder that is advantageously configured to manufacture meat replacement products preferably having protein fibres mostly aligned to be in parallel with each other-using high moisture protein texturization extrusion.

With regard to the extrudate retarders, extruder, methods, improvement, and also the flow bender, the extrudate retarder or flow bender is preferably designed to cause a restriction of the cross-section of flow conduit C, from an extruder outlet cross-sectional area CA to input cross-section area A34-I, such that ratio between input cross-section area A34-I and extruder chamber outlet area CA is between 12% and 40%, preferably between 15% and 30%, more preferably between 22% and 28%.

With regard to the extrudate retarders, extruder, methods, improvement, and also the flow bender, the extrudate retarder or flow bender is preferably designed to cause a restriction of the cross-section of flow conduit C, such that ratio between input cross-section area A34-I to extrudate retarder inlet area IA is between 30% and 80%, preferably between 35% and 60%, more preferably between 40% and 50%.

### LIST OF DRAWINGS

In the following, the aspects of extruder retarder, as well as the extruder and the extrusion method are explained in more detail with reference to the embodiments shown in the appended drawings, of which:

FIG. 1 shows an extruder retarder connected between an extruder and a cooling die;

FIG. 2 is an isometric view of an extruder retarder as seen from front (i.e. inlet end side) above the right side;

FIG. 3 is an isometric view of the extruder retarder of FIG. 2 as seen from the rear (i.e. outlet end side) below the left side;

FIG. 4 is the extruder retarder of FIGS. 2 and 3 as seen directly from the rear;

FIG. 5 is the longitudinal cross-section V-V of the extruder retarder in horizontal direction (cf. FIG. 4);

FIG. 6 is an explosion diagram of the cross-section V-V of some elements of FIG. 5;

FIG. 7 shows the elements of FIG. 6 in an isometric view;

FIG. 8 shows sheathing element of FIG. 7 placed into a cover of FIG. 14;

FIG. 9 shows aperture plate placed into the cover on top of the sheathing element;

FIG. 10 shows flow bender placed into the cover on top of the aperture plate;

FIG. 11 shows flow constrictor placed into the cover on top of the flow bender;

FIG. 12 shows the extrudate retarder in the cover, as seen directly from front;

FIG. 13 shows the extrudate retarder in the cover, as seen from the rear;

FIG. 14 is the longitudinal cross-section XIV-XIV of the extruder retarder in vertical direction (cf. FIG. 4);

FIG. 15 shows an extrudate after it has been solidified in a cooling die that was manufactured in an extruder configured to carry out high-moisture protein texturization and with a long cooling die, without using the extruder retarder;

FIG. 16 shows an extrudate after it has been solidified in a cooling die that was manufactured in an extruder configured to carry out high-moisture protein texturization and with a long cooling die, with the extruder retarder;

FIG. 17 shows a flow constrictor that is a blocking ring;

FIG. 18 shows the preferred arrangement of the blocking rings as a pair on opposing sides of the flow bender;

FIG. 19 illustrates a set of blocking rings available to be used pairwise as flow constrictors, each pair having a different blocking width;

FIGS. 20-23 illustrate the cross sections and dimensions used in the calculations.

Same reference numerals refer to same parts in all FIG.

### DETAILED DESCRIPTION

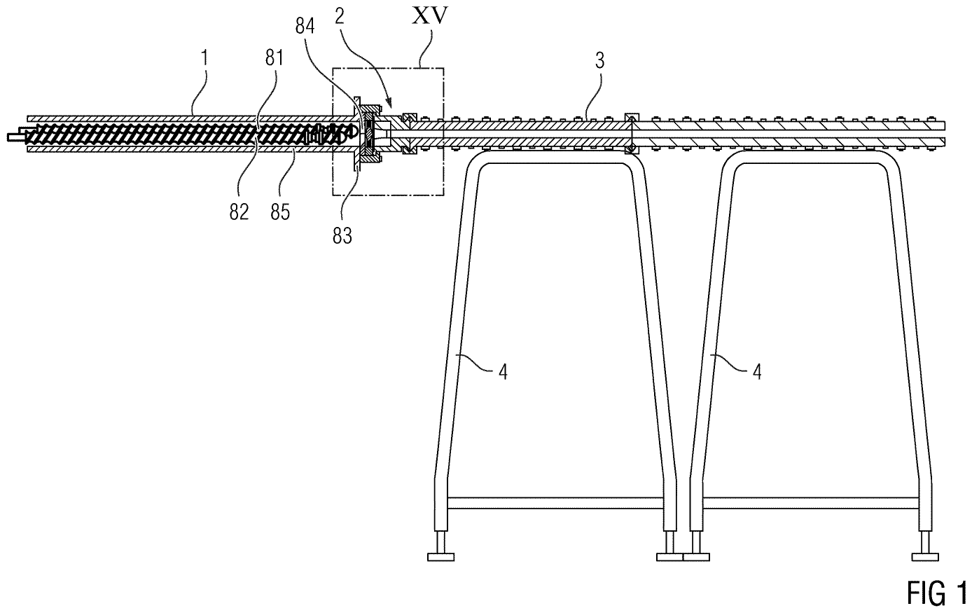

FIG. 1 shows an extruder retarder 2 connected between an extruder 1 and a cooling die 3. The cooling die 3 is a long cooling die having a length between 1000 and 5000 mm. The extruder 1 is a twin-screw extruder where the extruder screws 81, 82 are arranged in an extruder barrel 85. The melt extrudate exits the extruder 1 from the extruder outlet 84. The ingredient inlets, water inlet, power supply, heating elements, motor etc which the extruder 1 normally comprises are omitted from FIG. 1 for clarity. The extruder 1 is configured to carry out high-moisture protein texturization extrusion to manufacture food or animal feed. The cooling die 3 is supported by a support 4, such as a number of podests.

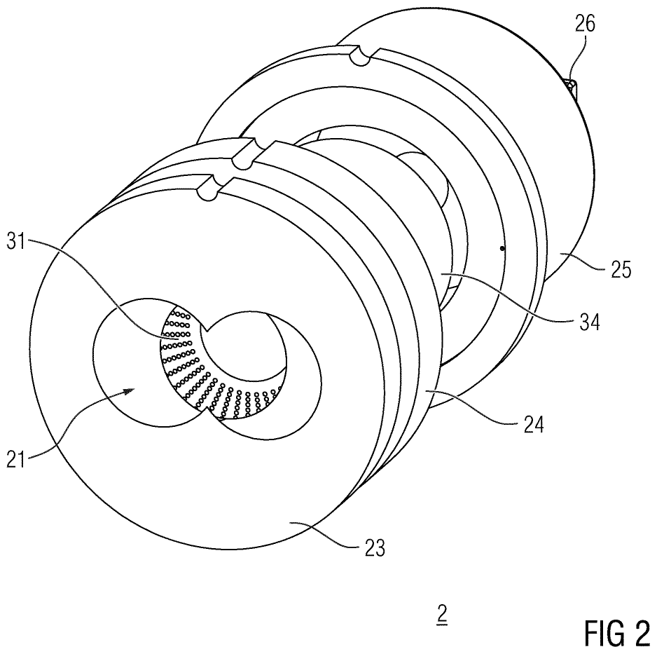

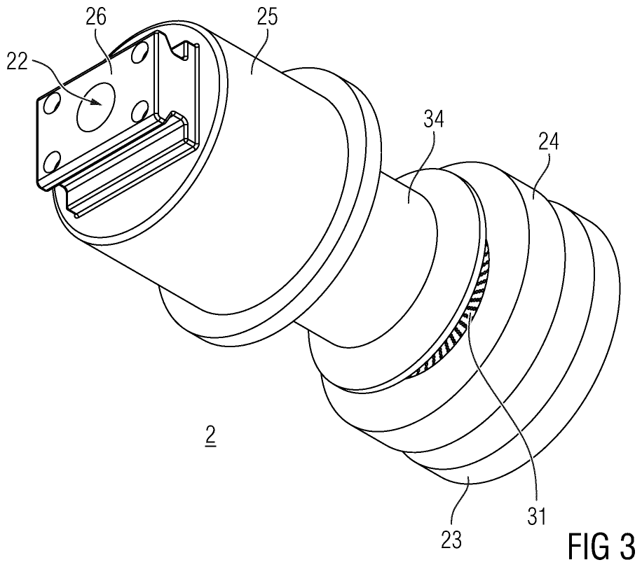

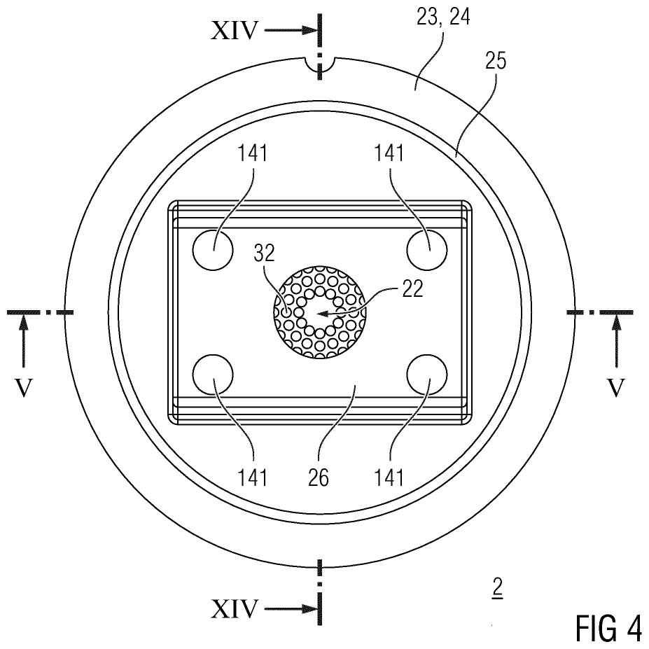

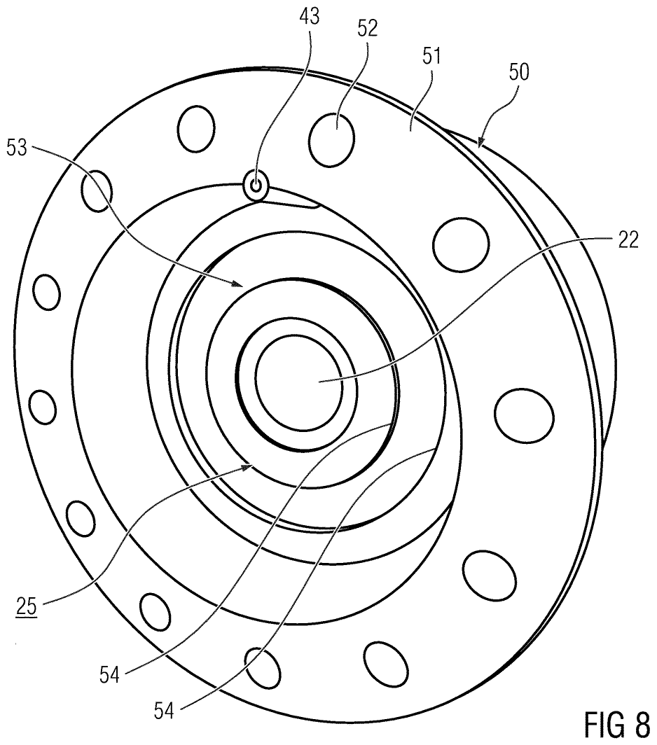

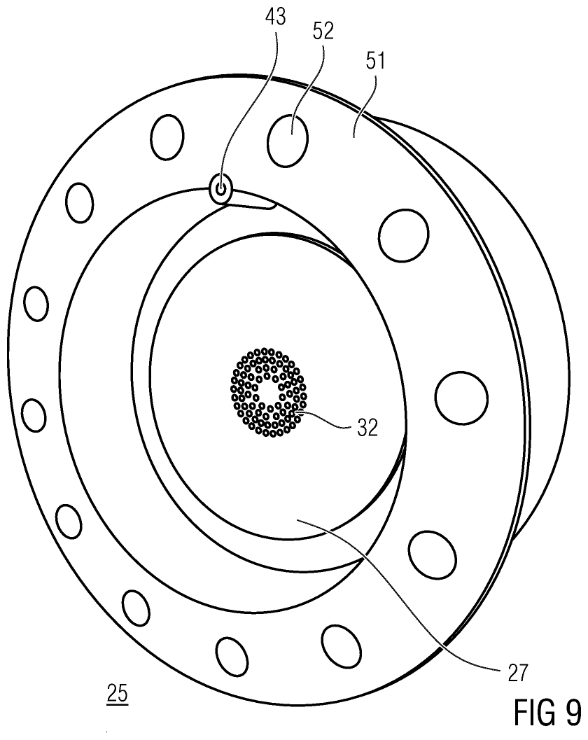

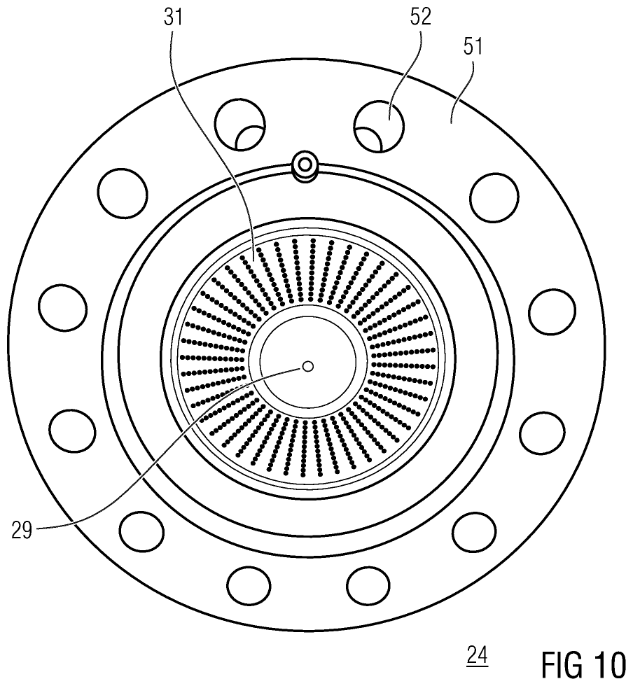

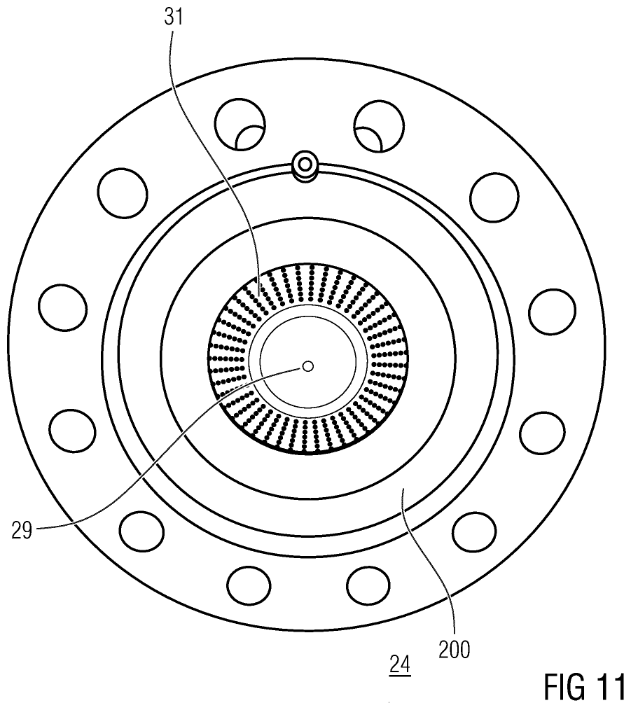

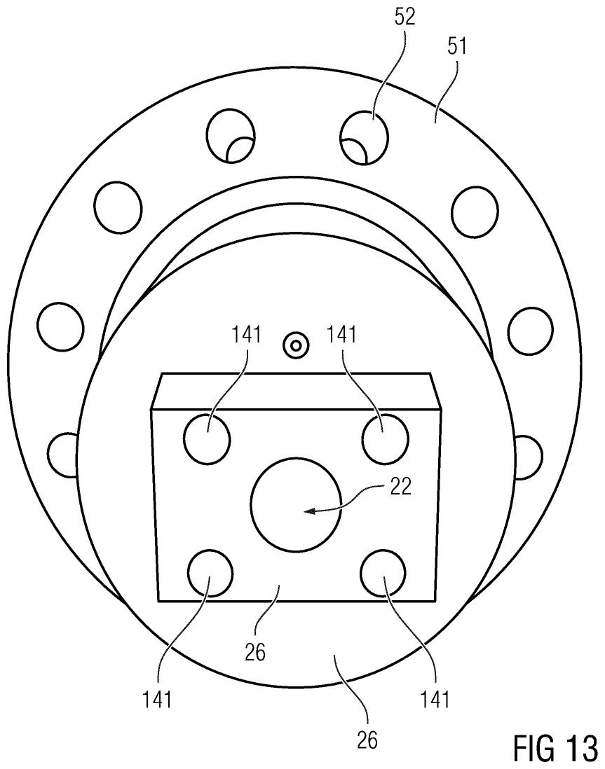

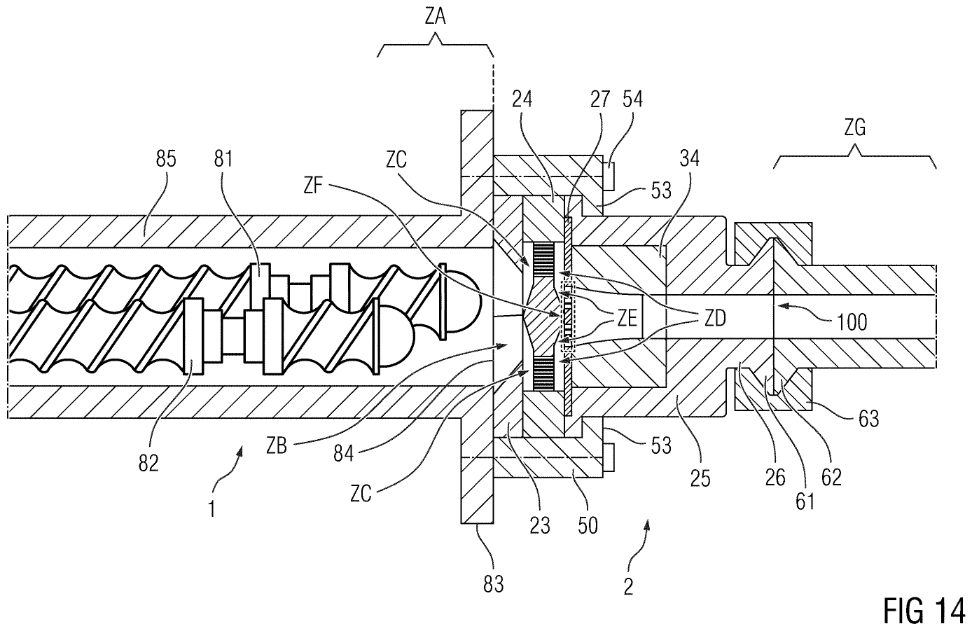

FIGS. 2-7 illustrate the extruder retarder 2 and its elements in more detail and FIGS. 8-12 illustrate how the extruder retarder 2 is assembled in cover 50. FIGS. 13 and 14 illustrate attaching the extruder retarder 2 to the extruder 1 and the cooling die 3.

Extrudate retarder 2 comprises an inlet end 21 as inlet for receiving a flow F of melt extrudate from an extruder 1, and an outlet end 22 as outlet for the flow F of melt extrudate to the cooling die 3. The elements of the extrudate retarder 2 form a flow conduit C which is suitable for the flow F of melt extrudate and is in flow connection between the inlet end 21 and outlet end 22.

According to the first aspect, the flow conduit C extends through a flow bender 24 located between the inlet end 21 and the outlet end 22. The flow bender 24 is configured to receive a flow F of melt extrudate and it has a flow conduit C that has an essentially circular cross-section which continues through an aperture 31 to have separated streams of melt extrudate along the ring, which in particular may be a circular ring section, where the section comprises at least 300°, preferably at least 325°, particularly preferably comprises at least 350°, and then further in the flow direction joins the separated streams to a uniform flow having an essentially cross-section. The joining is carried out through another aperture 32.

More specifically, the flow conduit C extends through a flow bender 24 located between the inlet end 21 and the outlet end 22. The flow bender 24 is configured to receive a flow F of melt extrudate and having a flow conduit C that has an essentially circular cross-section and to change the flow in the downstream to the flow direction to centrifugal flow or substantially radially outwards directed flow to an essentially ring-like cross-section that is larger than the circular cross section such that the flow continues through a first aperture 31 arranged in an aperture frame 31B that is plate-like or slab-like, such as plate or slab, to have separated streams of melt extrudate along the ring-like cross section, which in particular is a circular ring section, where the section comprises at least 300°, preferably at least 325°, particularly preferably comprises at least 350°, and then further downstream in the flow direction to turn the flow to a centripetal flow or substantially radially inwards directed flow to join the separated streams to a uniform flow having an essentially circular cross-section. The joining is carried out through another aperture 32 arranged in an aperture plate 27.

Between turning from substantially radially outwards directed flow to substantially radially inwards directed flow or from centrifugal to centripetal flow the flow passes through the first aperture 31 once.

The configuration of the flow bender 24 is preferably chosen such that the flow F of melt extrudate is in heat transfer connection with the flow bender 24 from opposite sides of the flow bender 24. As one example to achieve this purpose, the flow bender 24 may be designed to have a moderate thickness such that the distance between the inlet fitting 23 and the aperture plate 27 is between 10 and 100 mm, preferably between 20 and 50 mm, and more preferably between 30 and 40 mm. Alternatively or in addition, the aperture thickness (which is the distance between the entrance and exit of each aperture) may be limited to be between 4 and 60 mm, preferably between 10 and 30 mm, and more preferably between 15 and 22 mm.

The flow bender 24 preferably comprises an inflow deflector 29 and an outflow deflector 30 that are on opposite faces of the flow bender 24. The first aperture 31 has an essentially ring-like cross section which radially surrounds the inflow deflector 29 and the outflow deflector 30 but such that the first aperture 31 has a thickness that is less than the combined maximum thickness of the thickness of flow bender 24 measured at the position of the inflow deflector 29 and the outflow deflector 30.

According to the second aspect, the flow conduit C extends through a flow bender 24 configured to turn the flow F of melt extrudate through a U turn and/or an L turn arranged such that an aperture 31, 32 is located at the turn.

The flow bender 24 may be configured to turn the flow F of melt extrudate through a U turn and an L turn arranged such that an aperture 31, 32 is located at each turn.

The flow bender 24 may integrally comprise an outflow deflector 30. Alternatively, the outflow deflector 30 may be detachable from the flow bender 24. If the outflow deflector 31 is detachable, it may be held in place by the distance between the two apertures 31, 32 i.e. by the shape of the aperture 32 preventing the aperture 31 from moving with the flow F of melt extrudate.

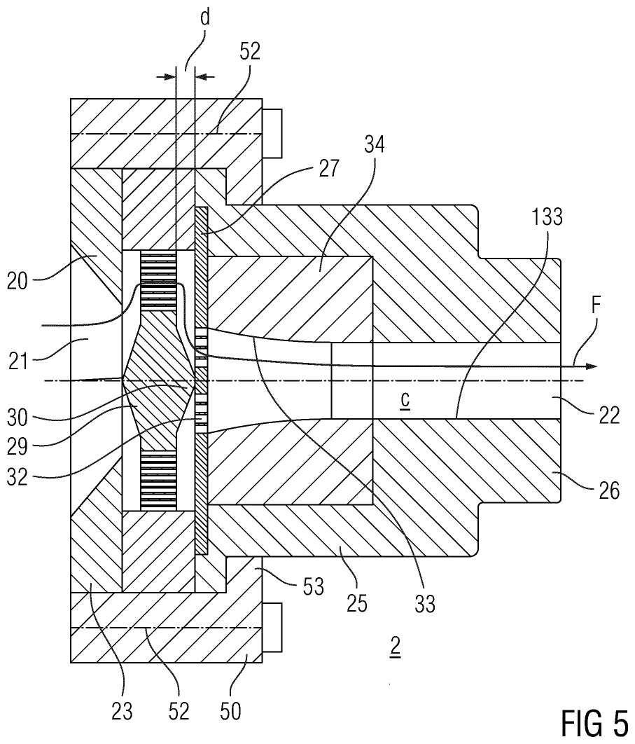

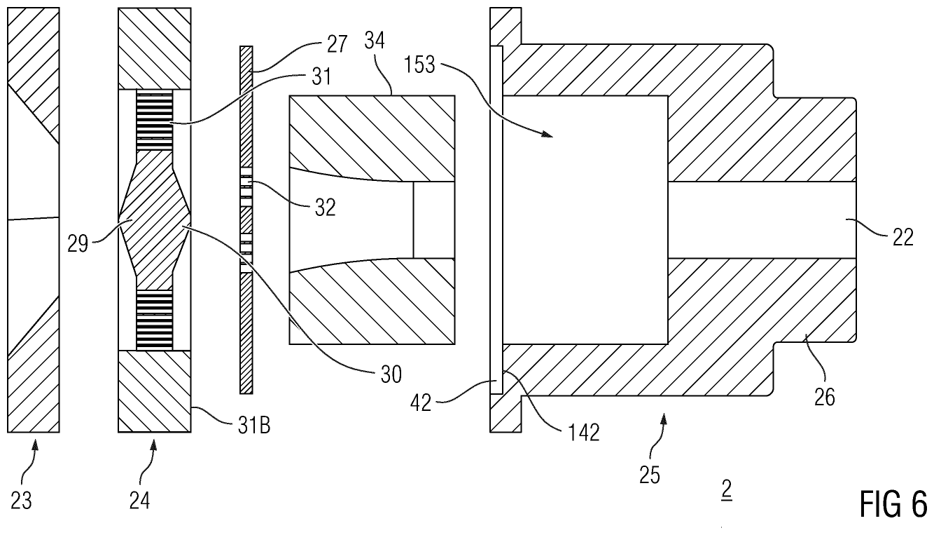

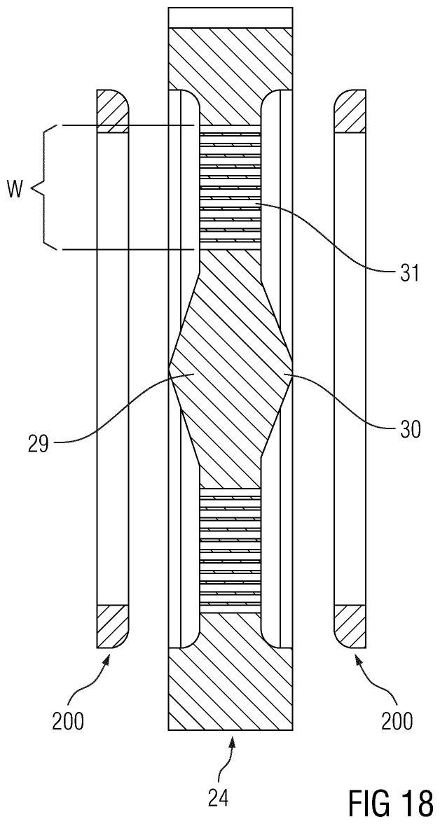

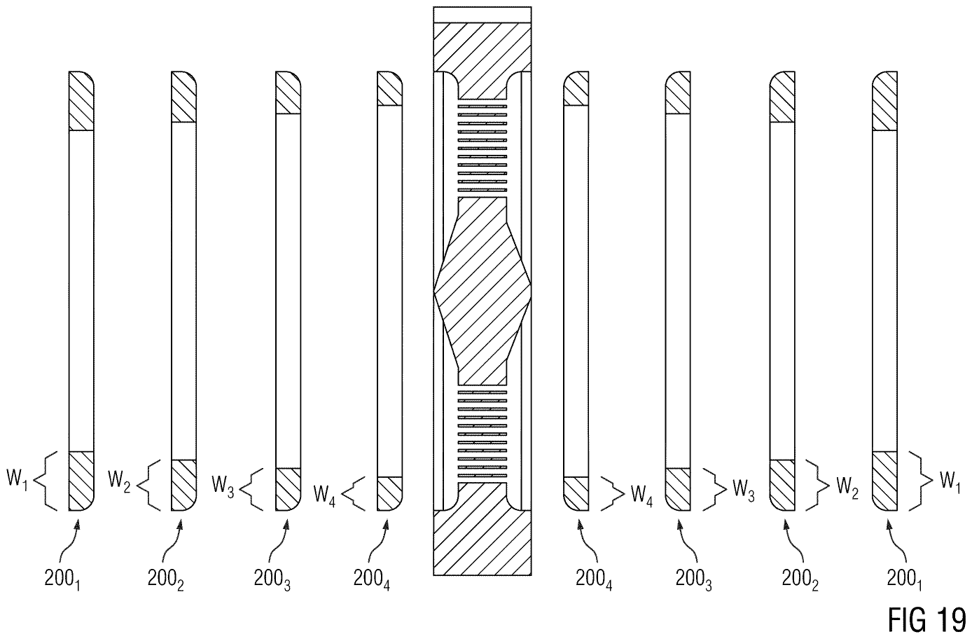

Further, the aperture 31 may be integral to the flow bender 24 (as illustrated in FIGS. 18 and 19) or detachable (as illustrated in FIGS. 5 and 6).

The flow bender 24 may be configured to cause the U turn by walls of the flow conduit C limiting to the aperture 31, assisted by inflow deflector 29 that preferably comprises a conical structure.

The flow bender 24 may be configured to cause the L turn by an outflow deflector 30 that comprises a conical structure.

According to the third aspect, the inlet end 21 is arranged in an inlet fitting 23 configured to fit with an extrudate outlet 84 of the extruder 1. The outlet end 26 is arranged as an outlet fitting 26 configured to fit with an extrudate inlet 100 of the cooling die 3. The extrudate retarder 2 comprises a stack of consecutive plate-like elements, including
i) a flow bender 24 comprising at least one aperture 31 that has a ring-shaped cross section, the flow bender 24 further comprising an inflow deflector 29 on its face against the direction of the flow F and an outflow deflector 30 on the opposite face, and
ii) an aperture plate 27 comprising an aperture 32 located in the direction of flow F of melt extrudate downwards and comprising an aperture 32 that has a circular cross-section.

More specifically, with regard to i), a flow bender 24 comprising at least one plate-like or slab-like aperture 31 that has a ring-shaped cross section, the flow bender 24 further comprising an inflow deflector 29 on its face against the direction of the flow for turning the flow to a centrifugal flow or substantially radially outwards directed flow, and an outflow deflector 30 on the opposite face for turning a centripetal flow or substantially radially inwards directed flow to substantially 90 degrees in the direction of a rotational symmetry axis of the ring (cf. dash-dot line in FIG. 5).

Optionally, the alignment position of at least some of the consecutive plate-like elements (preferably at least the inlet fitting 23, more preferably in addition to the inlet fitting 23 also the flow bender 24, and most preferably in addition to these also the sheathing element 25 and the aperture plate 27) is assisted by a positioning member such as a stick/pin 43. In this situation, the respective plate-like elements comprise form-locking means such as a notch to engage with the positioning member.

The flow bender 24 may be held in place between an inlet fitting 23 and a sheathing element 25 by a cover 50 fastened to the extruder 1 preferably via a bolt connection (cf. FIG. 14). The cover 50 preferably comprises a shoulder via which the stack is held in place.

The sheathing element 25 may comprise a recess 153 for receiving a funnel element 34. The funnel element 34, when in place, preferably lays flat with the aperture plate 27 to prevent flow of melt extrudate from entering the space between the aperture plate 27 and funnel element 34 outside of the aperture 32 and a tapering section 33 forming the funnel.

The sheathing element 25 may comprise a recess 42 for receiving an aperture plate 27 and have at least one shoulder 142 to support the aperture plate 27.

The extrudate retarder 2 may comprise a funnel element 34 comprising a tapering section 33 that forms a funnel and which is placed in the recess 53 of the sheathing element 25, and an aperture plate 27 comprising at least one aperture 32 resting on the at least one shoulder 142 such that the at least one aperture 32 overlaps with the funnel.

According to the fourth aspect, the flow bender 24 is configured to divert the flow F of melt extrudate around a number of bends, such as in particular U and/or L turn, where at the bends, an aperture 31, 32 is arranged for the flow F to go through. Furthermore, an optional flow constrictor 200, such as a blocking ring 200ᵢ, which can be arranged in any positive number (i.e. i=1, 2, 3, 4, . . . , N where N is the chosen max number of blocking rings) between a flow bender 24 at least to partially cover the aperture 31.

More specifically, the flow bender 24 may be configured to divert the flow of melt extrudate around a number of bends, namely in particular U turn and L turn following each other in this order, where at each of the bends, an aperture (aperture 31, aperture 32) is arranged for the flow to go through, and further an optional flow constrictor 200ᵢ (cf. FIG. 19) between a flow bender at least to partially cover the aperture. This enables an easy manner of implementing adjustability for the retarding effect.

The flow constrictor 200 may comprise a first blocking ring 200ᵢ and a second blocking ring 200ᵢ arranged on (and fitting tightly against) opposite sides of the flow bender 24 such that they partially block the aperture 31 of the flow bender 24. The opposite blocking rings 200ᵢ preferably have the same blocking width wᵢ. Alternatively, a blocking ring 200ᵢ may have a different blocking width wᵢ than the other blocking ring 200ⱼ which has as its blocking width wⱼ. In this situation, of course, i≠j.

The flow constrictor 200 which are blocking rings 200ᵢ may be provided in a set, such that in the set, rings or pairs of rings have different blocking widths wᵢ.

The flow bender 24 comprises an outlet deflector 30 that is formed integrally in the flow bender 24 or arranged removably such that it can be replaced.

The flow bender 24 comprises an inlet deflector 29 that is formed integrally in the flow bender 24 or arranged removably such that it can be replaced.

The extrudate retarder 2 may comprise a tapering section 33 that is located in the flow direction downwards from an aperture plate 27, forming a funnel such that the cross-section of the flow channel C gets narrower in the direction of the flow F of melt extrudate.

A straight section 133 may follow in flow direction after the tapering section 33.

The inlet end 21 preferably has a shape defined by an inlet fitting 23 configured to match an extrudate outlet 84 of the extruder 1. Preferably, the inlet fitting 23 is exchangeable.

The extrudate retarder 2 may comprise or consist of stainless steel, but at least the flow conduit C has walls limiting the flow conduit C, all of which consist of or comprise stainless steel, such that the stainless steel features a high grade of food compatibility, preferably such that the stainless steel is in conformity to EN 10088 classification numbers 1.43xx or 1.44xx.

The flow conduit C has walls limiting the flow conduit C, all of which have roughness in the range of R_{α} 1, 6 to R_{α} 0, 8 in accordance with DIN EN ISO 4287:1998.

The extruder 1 configured to carry out high-moisture protein texturization extrusion—advantageously to manufacture meat-replacement products preferably having protein fibres mostly aligned to be in parallel with each other—comprises a number, preferably two, extruder screws 81, 82 arranged in an extruder barrel 85, is connected to an extrudate retarder 2, the inlet end 21 of which is connected to an extrudate outlet 84 of the extruder 1, preferably between the extruder flange 83 and the cover 50 with a number of bolt connections, for example. The outlet end 22 of the extrudate retarder 2 is connected to an extrudate inlet 100 of the cooling die 3.

The extrudate retarder 2 comprises an inlet fitting 22 which has shape of extrudate outlet 84 which is a twin-screw extruder outlet such that, when the extrudate retarder 2 is connected to the extruder 1, a pressure-tight connection between extruder 1 and the extrudate retarder 2 is achieved to restrict the flow of the melt extrudate from the extrudate outlet 84 via the flow conduit C into outlet end 22 and from there further to the cooling die 3.

The improvement to high-moisture protein texturization extrusion method—advantageously to manufacture meat-replacement products preferably having protein fibres mostly aligned to be in parallel with each other—is that the retention time of the extrudate at screws 81, 82 and barrel 85 of an extruder 1 and also the travel time of flow F of melt extrudate from an extrudate outlet 84 of the extruder 1 to a cooling die 3 are prolonged using an extrudate retarder such that the melt extrudate passes through a flow conduit C of the extrudate retarder 2 passing via the flow bender 24.

In the method of performing high-moisture protein texturization extrusion—advantageously to manufacture meat-replacement products—preferably having protein fibres mostly aligned to be in parallel with each other (preferably high-moisture protein texturization extrusion of food or animal feed) with an extruder 1 having a cooling die 3, between an extrudate outlet 84 of the extruder 1 and an extrudate inlet 100 of the cooling die 3, an extrudate retarder 2 is used such that the melt extrudate passes through a flow conduit C of the extrudate retarder 2 and thereby goes through the flow bender 24.

In a method of manufacturing meat replacement products—preferably having protein fibres mostly aligned to be in parallel with each other—using high-moisture protein texturization extrusion, a flow of melt extrudate having a gel-like substance and exiting an extruder barrel 85 is treated in an extrudate retarder 2 comprising a flow conduit C and located immediately after the extruder barrel 85, the flow conduit having directional turns and a narrowing cross-section, such that the directional turns and the narrowing cross-section are selected so that the storage modulus of the melt extrudate flow in the extrudate retarder is utilized to prevent extrudate blow-outs or melt extrudate from uncontrolledly escaping from the extruder barrel 85. This increases the controllability of the method since extrudate blow-outs may be reduced or avoided. Further, extrudate quality may be improved.

In a method of increasing manufacturing capacity of meat replacement products—preferably having protein fibres mostly aligned to be in parallel with each other—production where high-moisture protein texturization extrusion is used, retention of extrudate at an extruder 1 having an extruder barrel 85 is improved with an extrudate retarder 2 comprising a flow conduit C and located immediately after extruder barrel 85, the flow conduit C having directional turns and a narrowing cross-section, such that retention time of extrudate between entering the extruder and entering a cooling die is increased.

In the methods, the extruder described above is preferably used.

The flow of melt extrudate may be passed through a first aperture 31 having channels having a first cross section area, and then in the flow direction through an aperture 32 having channels having a second cross section area, which is larger than the first cross section area. The first cross-section area may be in the range of 3.46 mm²-7.07 mm², and the second cross section area may be selected from the range of 7 mm²-17 mm² such that it is larger than the first cross-section area.

The ratio of total area of all channels of the aperture in flow bender 24 to the area of extruder barrel 85 cross section is preferably between 12% and 25%.

The ratio of total area of all channels at the aperture 32 located in downstream to the flow bender 24 to the area of extruder barrel 85 cross section is preferably between 9% and 14%.

The extrudate retarder 2, especially its cover 50, may further comprise a stick/pin 43 that preferably comprises a threaded hole. The stick/pin 43 can assist with aligning the elements of the extrudate retarder, especially of those parts that are located within cover 50. This may improve the accuracy of positioning the inlet fitting 23, for example, in a correct position with regard to the extrudate outlet 84. The elements for which the stick/pin 43 assists to keep the positioning, preferably have a notch, preferably along their circumference, so that the stick form-locks the elements.

In other words:

The extrudate retarder 2 is a kind of pressurizing apparatus for high moisture protein texturization extrusion. The extrudate retarder 2 is connected to the extruder 1 as a transition part linking between the extruder barrel 85 (chamber) and cooling die 3 assembly (which is known as “long cooling die” but is for the sake of clarity referred to as “cooling die”). The extrudate retarder 2 increases the texturization power of the extruder 1. Consequently, it increases the production capacity (extrudate production rate in kg/h) while enabling maintaining the quality of the extrudate product.

The extrudate retarder 2 provides at least these functions:
(1) retards the melt extrudate (which, as defined above, refers to the proteinaceous slurry that has been treated in the extruder by shearing, kneading and heating and exits the extruder barrel after high-moisture protein texturization extrusion preferably to manufacture meat replacement products) from leaving the extruder barrel 85;
(2) increasing the pressure inside the extruder barrel 85;
(3) mixing and homogenizing the melt extrudate before it enters the cooling die 3.

The extruder retarder 2 is preferably designed so that it provides space (flow conduit C, especially flow bender 24) that guides the direction of the melt extrudate movement, such that the melt extrudate substantially moves along with routes that are substantially centrifugal at first, and then centripetal before it enters the cooling die 3. The centrifugal and centripetal routes are substantially or nearly perpendicular to the direction of the screws 81, 82. The routes in the flow conduit C contain narrowing cross-sections (e.g. narrower gap, narrower channels) that provide flow retardation and pressurization (blocking effect).

The extruder retarder 2 is located substantially close to the barrel 85, so that the melt extrudate in the centrifugal movement has high temperature (110-200 °C, preferably 120-150 °C) and is thus melt extrudate. The extruder retarder 2 is preferably designed with a short horizontal dimension (along with the direction of the screws 81, 82), so that the melt extrudate remains in high temperature (100-200 °C, preferably 110-150 °C) i.e. melt extrudate before entering the cooling die 3. The melt extrudate has higher flowability and lower viscosity when it is at higher temperature. The location and the design of the extruder retarder 2 provides at least these technical advantages:
(1) the melt extrudate is maximally retained inside the barrel 84;
(2) the melt extrudate can stably flow in the routes in the apparatus despite the turning directions;
(3) the melt extrudate can mix well before it enters the cooling die 3.

As a result, the extruder retarder 2 increases the pressure of inside the extruder barrel 85, extends the retention time of the slurry in the extruder barrel 85, and improves the texture when moisture content and capacity are in high level.

The extruder retarder enables the possibility to use a shorter or smaller cooling die for higher capacity of high moisture protein texturization extrusion. Depending on the desired quality and types of extrudate products, minimum would be 300 mm, preferably minimum 800 mm, more preferably minimum 1000 mm. The extruder retarder 2 improves the evenness of product quality in terms of the flow evenness in the cooling die.

High moisture extrusion is a process that can produce fibrous muscle-like texture plant-based meat analogue using plant protein, for example, as the main ingredient. One limit of the high moisture extrusion is that the capacity (on dry weight basis) is much lower than low moisture extrusion. The reason is that, compared with low moisture extrusion, the melt extrudate in high moisture extrusion has a much higher moisture content and needs much higher energy input to reach a desirable degree of texturization. When production rate is higher than its limit, the extrusion process may be unstable and the extrudate may have less degree of texturization. Another limit is that the cooling die is either very long (flat channel die) or very large (ring channel die) to cool down the extrudate and to increase the friction between extrudate and cooling die to hold the pressure inside extruder barrel. Otherwise, the extrusion may become unstable and the extrudate has less degree of texturization. Unwanted release of the pressure from extruder barrel is sometimes referred to as blowout. The extrudate retarder 2 may help to avoid such blowouts.

The extrudate retarder 2 may also help to faster resume to normal production in cases when blowouts happen for other reasons. In contrast, in extrusion without extrudate retarder 2, the extrusion resumes to normal production much more slowly, because the extruder barrel and long cooling die become empty after blowout-happening and need longer time to refill and rebuild the pressure.

The movement routes of the melt extrudate in the extrudate retarder 2 are explained with the different functional and related zones in the extrudate retarder 2.
Zone ZA. The barrel 85 of the extruder 1 where screws are located;
Zone ZB. Between inlet fitting 23 and flow bender 24, the centrifugal movement of the melt extrudate started, high resistance force provided by the design to increase to pressure which slows the movement of the melt extrudate from the extruder barrel 85 to extrudate outlet 84, and hence, increases the retention time at zone ZA and pressure at zone ZA.
Zone ZC. In the flow bender 24, at the inflow deflector 19, the melt extrudate turns 90 degree again, followed by entering a narrowing cross-section. As a result, high resistant force provided, and hence, increased retention, and increased pressure to zone ZB and zone ZA.
Zone ZD. In the flow bender 24, the melt extrudate turns 90 degree again, increased resistant force etc.
Zone ZE. In the flow bender 24, the centripetal movement of melt extrudate, which resulted in higher resistant force, better mixing or homogenization.
Zone ZF. In the flow bender 24, at the outflow deflector 30, the melt extrudate turns 90 degree again, followed by entering a narrowing cross-section. As result, high resistant force provided, and hence, increased retention, and increased pressure to zone ZB and zone ZA.
Zone ZG. the cooling die 3.

The extrudate retarder 2 is-between extruder barrel 85 and long cooling die 3. Said apparatus has at least two functional parts, part I (flow bender 24) and part II (aperture plate 27 with aperture 32).

Part I connects to the extruder barrel 85 (via a 2-to-1 channel plate i.e. inlet fitting 23). Part I has at least one channel. The ratio of total area of all channels in part I to the area of extruder barrel cross section is in the range of 12%-25%. It is preferable to have in aperture 31 channels with small cross section area in the range of 3.46 mm²-7.07 mm². Said channel(s) are not in the middle area of the part I. Part I guides said melt extrudate takes a 90-degree turning and flows toward said channels, then said melt extrudate take another 90-degree turning and flow through said channel(s). The advantage of part I is to guide said high temperature, high flowability, low viscosity melt extrudate to make a U turn route in a very short distance and decrease cross section area to increase pressure and said melt extrudate's retention time in extruder barrel. We noticed that without part I, the production is unstable with high production rate.

Part II connects to a cone shape channel (such as, tapering section 33) or cooling die 3. Said cone shape channel connects to cooling die. Part II has at least 14 channels. The ratio of total area of all channels in part II to the area of extruder barrel cross section is in the range of 9%-14%. It is preferable to have channels in aperture 32 with small cross section area in the range of 7 mm²-−17 mm². Said channel(s) are in the middle area of aperture 32. After said melt extrudate pass through part I channel(s), part II guides said melt extrudate to take a 90-degree turning and flows toward said channels in the middle of part II, then said melt extrudate take another 90-degree turning and flow through said channel(s) (apertures) in part II. The advantage of part II is to guide said high temperature, high flowability, low viscosity melt extrudate to flow back in the middle toward the cooling die and decrease cross section area to further increase pressure and said melt extrudate's retention time in extruder barrel 85. Another advantage of part II is to first homogenize, then direct said melt extrudate to the direction of cooling die channel by guide said extruded melt extrudate to mix in the middle and then flow through the channels. We noticed that without part II, the extrudate was disruptive and uneven, extrudate in middle of the cooling die moves much faster than edges.

Between part I and part II there is a gap d preferably in the range of 5 mm-12 mm. The gap was designed to be narrow so that when said melt extrudate pass through channels of part II, said melt extrudate will not cool down too much, and said melt extrudate is still in high temperature, high flowability, and low viscosity.

Between part I and 2-to-1 channel plate (apertures 31, 32) there is preferably a gap in the range of 5 mm-12 mm. The gap was designed to be narrow so that when said melt extrudate pass through channels of part I, said melt extrudate will not cool down too much, and said melt extrudate is still in high temperature, high flowability, and low viscosity.

### Effect on Extrudate Quality: Example 1

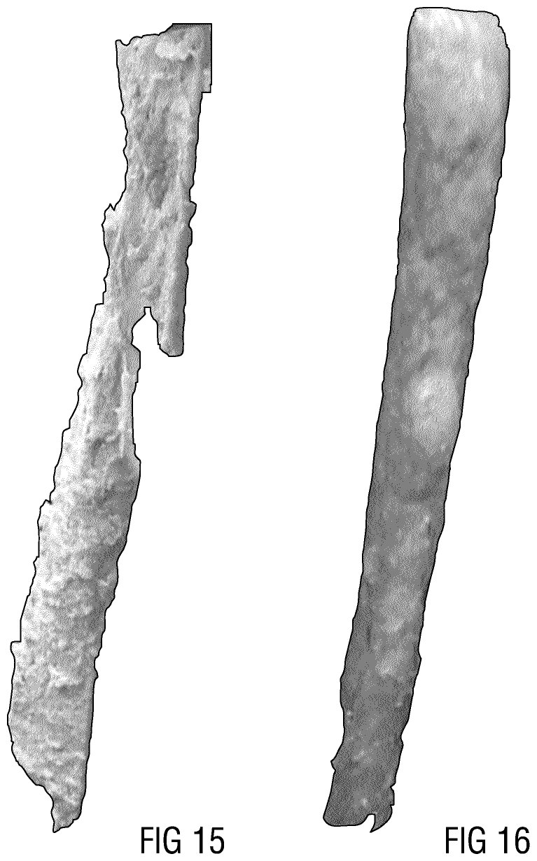

Applied only part I, without part II, in high moisture protein texturization extrusion, the extrudate was disruptive and uneven. Extrudate in the middle of the cross-section area came out much faster than extrudate in edges. The extrusion production was shooting and unstable. The result is shown in FIG. 15.

In contrast, when both part I and part II were applied, the extrudate had a smooth surface, continuous and even structure. The extrusion production was stable. The result is shown in FIG. 16.

### Flow Constrictor

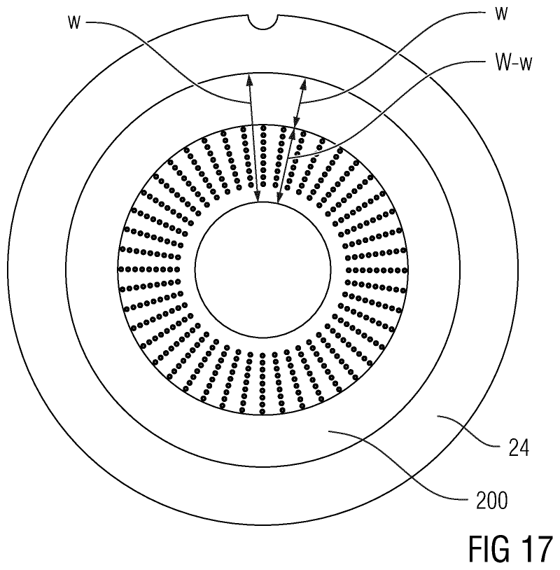

We tested blocking 40% channels of flow bender 24 by using flow constrictor 200 (FIG. 17) that was a blocking ring so that the total cross-section area of all the channels was reduced by 40%. We noticed that, compared with non-blocked flow bender 24, using partially flow bender 24 increased the pressure of the end part of extruder barrel 85 from 0.6 mPa to 0.7 mPa.

An idea behind the invention is the understanding of viscoelastic properties of the melt extrudate. The storage modulus G′ melt extrudates of at least for some vegetable proteins, is always larger than the loss modulus G″, which indicates that the melt extrudate has a gel-like (solid-like) property. Thus, the centrifugal movement, centripetal movement and narrowing cross-sections can effectively block the flow of the melt extrudate and in this manner increase the retention time and pressure at the extruder barrel 85. Reference data for G′ and G″ (as a function of temperature) can be found in Osen, R, Texturization of pea protein isolates using high moisture extrusion cooking, PhD thesis, TU München (2017).

The apparatus includes at least two plates. Both plates have more than one channel. It can increase the mass retention time inside extruder barrel, so that the extruder is able to handle 100% more mass with good texture quality.

The first plate (near the extruder barrel) which is close to extruder screws, has channels which are not in the middle of the plate. Preferably the channels have the same shape and same area size, so that the mass can evenly go through the channels. By applying the first plate, mass is staying in the extruder barrel for longer time (longer retention time), extruder screw end pressure is higher, the extrudate is better texturized and water absorbed.

The second plate has channels which are in the middle of the plate. Preferably the channels have the same shape and same area size. By applying the second plate, the retention time is further extended, and the mass are guided into a forward direction so that the fibers are well aligned in the same direction.

When the extruded mass flowing through the apparatus, the route is not straight forward but first to side area where plate A channels are located, then flowing back to the middle of the second plate, where channels are located.

### Experimental Results

We have tested the extrudate retarder 2 in high-moisture protein texturization extrusion. For this purpose, the extrudate retarder 2 was connected to extrudate output of a twin-screw extruder 1 (in our experiments, a twin-screw extruder with screw diameter of 72 mm, with the ratio of screw length to diameter as 24:1 (24D), and main motor power 110 kw). A 2500 mm long cooling die was used.

The following ingredient recipe was used during extrusion: pea protein isolate about 2:3 of the mass of dry ingredients, oat ingredients about 1:3 of the mass of dry ingredients. Water feed was about 2:3 of the mass of dry ingredients.

Instead of these dry ingredients, the following could be used in tge extrusion as dry ingredients: legume protein isolate and/or concentrate (such as pea protein isolate and/or concentrate) together with cereal ingredients (such as oat ingredients-such as oat flour, oat bran, or steel-cut oat, or a combination of two or three of these). The dry ingredients may further include salt and/or mineral salt like Calcium salt, spices, possibly also protein from other sources, and oil.

The extrusion was carried out by feeding dry ingredients to the extruder, under addition of water or water-based liquid under conditions selected to produce a meat replacement product having protein fibres mostly aligned to be in parallel with each other using high-moisture protein texturization extrusion.

The results are summarized in Table.

TABLE
Experimental results

| | 25.02.2021 | 26.02.2021 | 26.02.2021 | 09.04.2021 | 11.03.2021 | 11.03.2021 |
|---|---|---|---|---|---|---|
| Time | 14:33 | 12:01 | 12:49 | 10:14 | 13:35 | 14:01 |
| Production rate of solid | 60 | 60 | 80 | 90 | 100 | 125 |
| feeder speed, the speed of | | | | | | |
| flour input (kg/h) | | | | | | |
| Liquid water input into the | 51 | 51 | 64.8 | 67.5 | 70 | 73.7 |
| extruder (kg/h) | | | | | | |
| Screw speed (rpm) | 200 | 200 | 220 | 230 | 250 | 250 |
| Temperature (°C) for screw | 80 | 81 | 80 | 80 | 81 | 81 |
| barrel zone 2 | | | | | | |
| Temperature (°C) for screw | 123 | 132 | 129 | 124 | 134 | 132 |
| barrel zone 3 | | | | | | |
| Temperature (°C) for screw | 161 | 168 | 167 | 171 | 175 | 166 |
| barrel zone 4 | | | | | | |
| Temperature (°C) for screw | 156 | 155 | 156 | 152 | 158 | 167 |
| barrel zone 5 | | | | | | |
| Temperature (°C) for screw | 142 | 148 | 153 | 162 | 146 | 146 |
| barrel zone 6 | | | | | | |
| Pressure at the plate | 0.6 | 0.6 | 0.7 | 0.8 | 0.8 | 1.0 |
| between the screw and | | | | | | |
| retarder (mPa) | | | | | | |
| Temperature (°C) at the plate | 137 | 139 | 136 | | 138 | 141 |
| between the screw and | | | | | | |
| retarder | | | | | | |
| Cooling die temperature (°C) | ~100 | ~100 | ~100 | ~100 | ~100 | ~100 |
| Ratio of added water to solid | 85% | 85% | 81% | 75% | 70% | 59% |
| feed flour | | | | | | |
| Moisture content during | 51% | 51% | 50% | 49% | 47% | 43% |
| extrusion | | | | | | |
| Total throughput (kg/h) | 111 | 111 | 144.8 | 157.5 | 170 | 198.7 |
| Quality | Good, good | Good, good | Good, good | Good, good | Good, stable, | Good, good |
| | expansion, | expansion, | expansion, | expansion, | smooth intact | expansion, |
| | stable | stable | stable | stable, smooth | | stable, smooth |
| | | | | intact | | intact |

Without the extrudate retarder, the same recipe could be processed with the same extruder with approximately 50 kg/h capacity. This is what we call extruder baseline high-moisture protein texturization capacity. When the extruder was configured to run the same recipe with a higher capacity, extruder blowouts (shooting) occurred frequently.

With the extrudate retarder 2, a total throughput could be increased to 2,1 to 4,0 of the extruder baseline high-moisture protein texturization capacity. This is a significant improvement. At the same time, the extruder blowout (shooting) frequency was observed to be low.

We performed a further test with the extrudate retarder 2 connected on the same extruder 1. The extruder 1 was running the same recipe under conditions selected to produce a meat replacement product as high-moisture protein texturization extrusion. In this test, a 1500 mm cooling die was utilized. The extrudate quality was similar to that of obtained with a 2500 mm cooling die. Thus the extrudate retarder 2 may also enable using a shorter cooling die in high-moisture protein texturization extrusion. Using a shorter cooling die is advantageous as it saves production space in the factory, and uses less metallic materials to build the cooling die. Without being bound to any theory, this advantage of utilizing a short cooling can be attributed to the extruder retarder that generates increased pressure and extrudate retention time inside the extruder. Without the usage of such extruder retarder, the required pressure and extrudate retention time are generated by the long cooling die with long length.

### Dimensioning Aspects

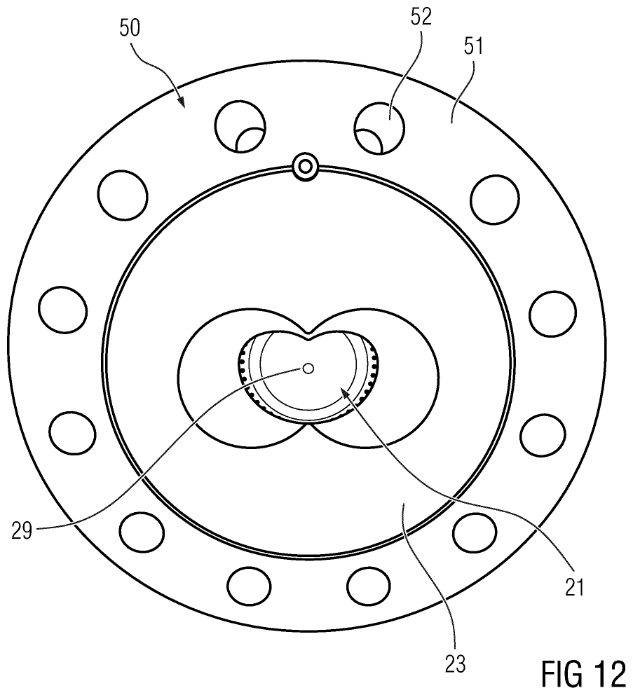

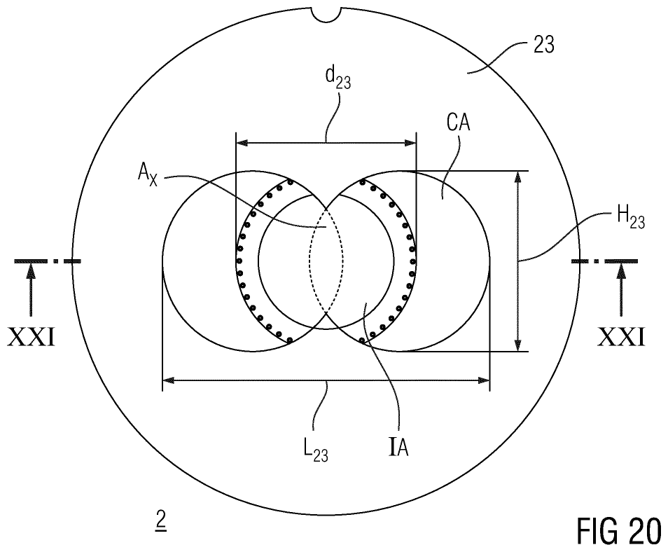

FIGS. 20-23 illustrate the cross sections and dimensions used in the calculations. FIG. 20 is the view of the extrudate retarder 2 as seen from the front (cf. also FIGS. 2 and 12). The inlet end 21 of the inlet fitting 23, in the example of FIG. 20 in the shape of the double screw outlet shape of an extruder 1 extrudate outlet 84 has width L23 (in the example L23=132 mm) and a height H23 (in the example H23=74 mm). The two screw circles are slightly overlapping. The cross overlapping area Ax=0,5*16 mm*43 mm=344 m2.

The extruder chamber outlet area CA thus equals 8256 mm² in the example.

The inlet fitting 23 by its funnel shape reduces this cross sectional area to an essentially circular shape with inlet end diameter d23. Thus the extrudate retarder inlet area IA. In the example IA=4299 mm2.

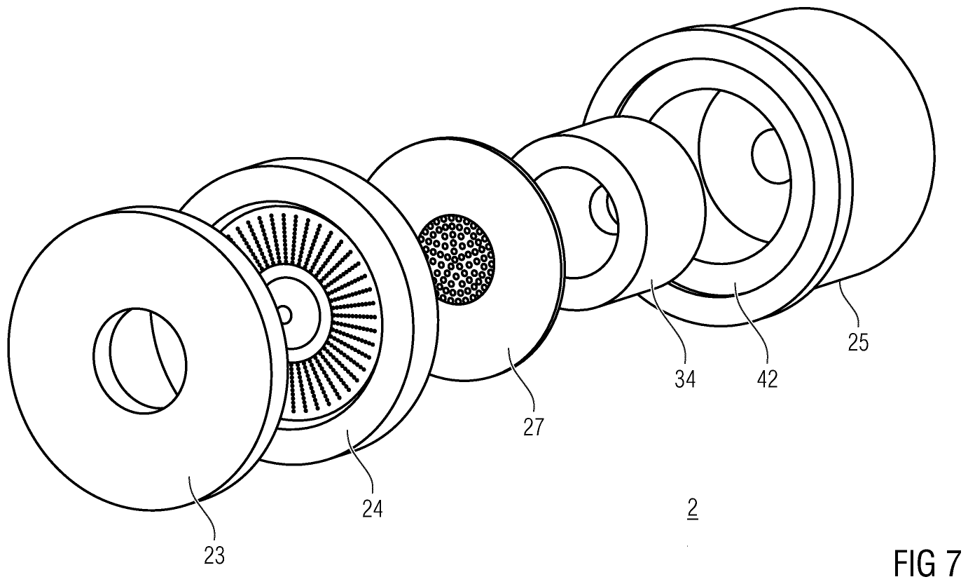

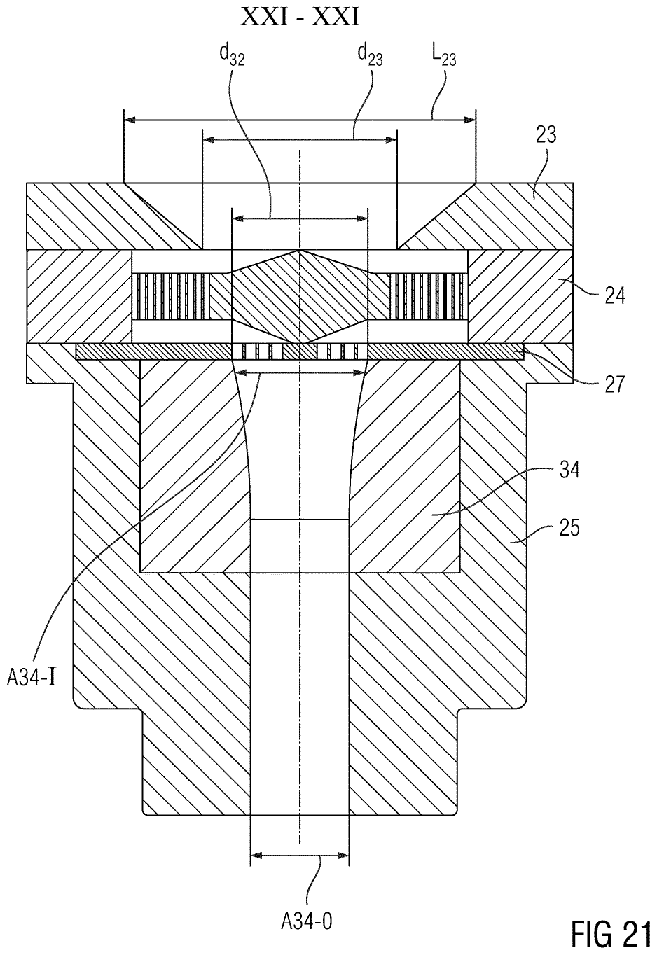

FIG. 21 is a horizontal section XXI-XXI shown in FIG. 20. As can be seen (cf. also FIG. 7), the aperture 31 which is located in aperture frame 31B of flow bender 24 has a ring-like cross section which is larger than the circular cross-section of the inlet fitting 23.

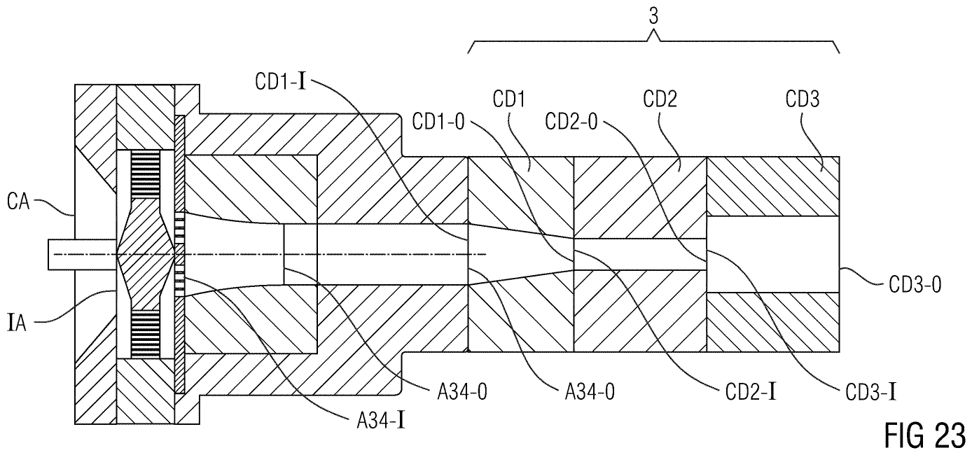

After the aperture plate 27 containing the aperture 32, the extrudate flow continues to floc conduit c that may be located in funnel element 34 and outlet fitting 26. The diameter of the flow conduit c is at the inlet end d34-I and at the outlet end d34-O. In the example, d34-I=51 mm which gives as area A34-I 2042 mm2, and d34-O=37 mm which gives as area A34-O 1074 mm2 (cf. also FIG. 23).

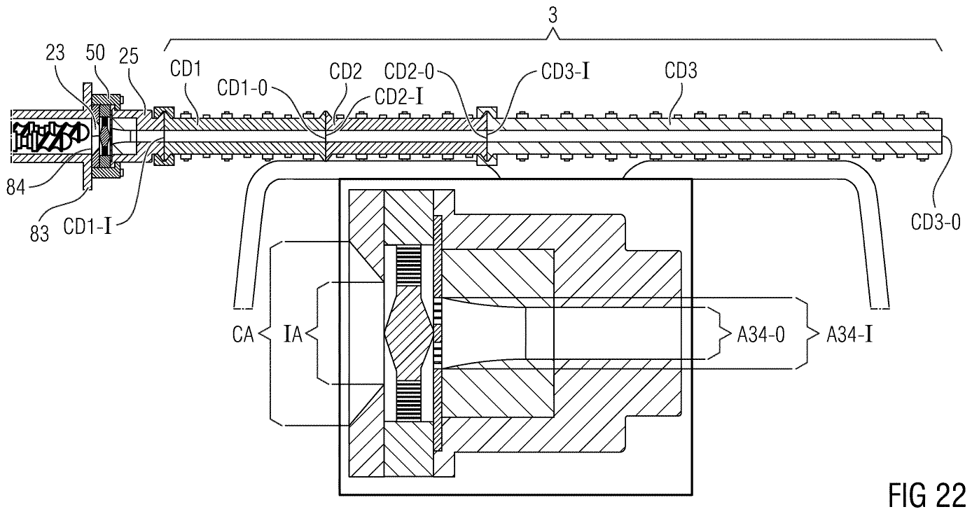

The preferable dimensioning is further explained in FIGS. 22 and 23. First cooling die CD1 has inlet (CD1-I) with cross-section area of 1074 mm2. First cooling die CD1 has outlet (CD1-O) with cross-section area of 420 mm2. These are exemplary values.

The second cooling die CD2 has an input (CD2-I) with cross section area as 420 mm2 and output cross-section area CD2-O as 420 mm2. The third cooling die CD3 has an input cross-section area CD3-I and output cross-section area CD3-O. For example, CD2-O=CD3-I=700 mm2.

The ratio between the input cross section area A34-I and extruder chamber outlet area CA may be between 12% and 40%, preferably between 15% and 30%, more preferably between 22% and 28%.

The ratio between input cross section area A34-I and the extrudate retarder inlet area IA may be between 30% and 80%, preferably between 35% and 60%, more preferably between 40% and 50%.

These ratios A34-I: CA and A34-I: IA reflect the requirement about having input cross section area A34-I narrower than extruder chamber outlet area CA and extrudate retarder inlet area IA, which then can support the second aperture 32 to provide necessary gas sealing, extrudate blocking and extrudate retarding effects, as when the combination of extrudate and steam moves through the second aperture, it is still facing an open area that is smaller than the open area (extrudate retarder inlet area IA) before the extrudate mass entering the first aperture 31.

### Extrusion Method Aspects

The extrusion is preferably carried out by feeding dry ingredients to the extruder 1, under addition of water or water-based liquid under conditions selected to produce a meat replacement product having protein fibres mostly aligned to be in parallel with each other using high-moisture protein texturization extrusion.

In the extrusion, as dry ingredients the following may be used: non-soy legume protein isolate and/or concentrate (such as: i) pea protein isolate and/or concentrate, ii) faba bean protein isolate and/or concentrate, or iii) a combination of i) and ii)) together with cereal ingredients—such as oat ingredients, preferably including one or more of the following: oat flour, oat bran, or steel-cut oat, or a combination of two or three of these.

In addition or alternatively, in the extrusion, the following can also be used as dry ingredients: soy protein isolate and/or concentrate, with or without cereal ingredients.

High moisture protein texturization extrusion using dry ingredient containing soy protein isolate and/or concentrate will be more easy to handle than using ingredients that use non-soy proteins like faba bean proteins and/or pea proteins, because soy protein can form homogenous protein matrix more easily than pea protein isolate and faba bean protein isolate do. In scientific publications, soy proteins often have been described to have a better solubility and gelling properties than pea protein and faba bean protein do. In extrusion for meat analogues, especially high-moisture protein texturization extrusion, soy proteins can be more easily controlled and processed than pea protein and faba bean proteins to form a fibrous and homogenous structure.

In the extrusion, when the non-soy legume protein contents weight ratio to the oat ingredient is below 2.5, the extrusion is harder to control and consequently the texturization will be harder to achieve. Without willing to be bound by theory, the present inventors believe that this may be because the lower protein content and higher carbohydrate content from the cereal ingredients alike oat ingredients will lower the extrudate viscosity at melt state inside the extruder and make less protein to contribute to building continuous phase and protein crosslinking matrix.

The extruder retarder or flow bender (preferably used with a further aperture plate containing a further aperture) may provide help to soy protein containing extrusion, but even more significant help it may provide to high-moisture protein texturization extrusion having protein fibres mostly aligned to be in parallel with each other using ingredients like non-soy legume protein isolate and/or concentrate (such as pea protein isolate and/or concentrate; and/or faba bean protein isolate and/or concentrate; or a combination of them) together with cereal ingredients (such as oat ingredients—such as oat flour, oat bran, or steel-cut oat, or a combination of two or three of these). With the extruder retarder or flow bender (preferably used with a further aperture plate containing a further aperture) such ingredients may be extruded under addition of water or water-based liquid under conditions selected to produce a meat replacement product. Salt, mineral (such as Calcium salt), oil and/or spices may be added.

The weight ratio of water or water-based liquid to dry ingredients may be 55% to 90%, preferably 58% to 87%, most preferably 59% to 85%.

The weight ratio of pea protein isolate and/or concentrate to oat ingredients may advantageously be between 1.5-3:1, preferably 1.7-2.5:1, most preferably essentially 1.86:1.

The moisture content during extrusion may be between 40% and 55%, preferably between 41% and 53%, most preferably between 43% and 51%.

### Flow Bender Aspects

A flow bender 24 comprises a steel plate or steel slab forming an aperture frame 31B having preferably an integral inflow deflector 29 and an integral aperture 31 surrounding the inflow deflector 29 and suitable for forming streams of melt extrudate from a stream of melt extrudate.

The flow bender 24 may be used in an extruder retarder 2 according to any one of the preceding aspects, in an extruder 1 according to any one of the preceding aspects, or in a method or improvement according to any one of the preceding aspects, respectively.

The inflow deflector 29 may comprise a conical structure.

The flow bender may further comprise an integrated outflow deflector that preferably comprises a conical structure.

The steel plate or steel slab may be essentially planar.

The flow bender is best used with a further aperture plate comprising an aperture, located in the flow direction downstream of the flow bender and containing an aperture.

The flow bender 24 is then preferably with the further aperture plate 27, dimensioned so that orifices or openings in the first aperture 31 are substantially not overlapping with orifices or openings in the further aperture 32, such that the flow bender 24 with the apertures 31, 32 jointly implement a gas seal for water vapor contained in the extruded mass, most preferably located between extruder barrel 85 and a first cooling die CD1 (cf. FIG. 23). In FIG. 21 it can be seen that the diameter d32 of the aperture 32 is smaller than the diameter of the ring-like section defined by aperture 31.

Although the flow bender 24 is in the embodiments presented as part of an extrudate retarder 2 that is attached after an extruder barrel outlet 84, the flow bender 24 may be arranged (possibly together with an inlet fitting 23 and preferably also with the further aperture plate 27 with the further aperture 32) inside the extruder barrel 85 before the extrudate outlet 84) in an extruder 1 that is advantageously configured to manufacture meat replacement products—preferably having protein fibres mostly aligned to be in parallel with each other-using high moisture protein texturization extrusion.

With regard to the extrudate retarders 2, extruder 1, methods, improvement, and also the flow bender 24, the extrudate retarder 2 or flow bender 24 is preferably designed to cause a restriction of the cross-section of flow conduit C, from an extruder outlet cross-sectional area CA to input cross-section area A34-I, such that ratio between input cross-section area A34-I and extruder chamber outlet area CA is between 12% and 40%, preferably between 15% and 30%, more preferably between 22% and 28%.

With regard to the extrudate retarders 2, extruder 1, methods, improvement, and also the flow bender, the extrudate retarder 2 or flow bender 24 is preferably designed to cause a restriction of the cross-section of flow conduit C, such that ratio between input cross-section area A34-I to extrudate retarder inlet area IA is between 30% and 80%, preferably between 35% and 60%, more preferably between 40% and 50%.

### LIST OF REFERENCE NUMERALS USED

1 extruder
2 extrudate retarder
3 cooling die
4 support
D gap
C flow conduit
F flow of melt extrudate
ZA, ZB, ZC, ZD, ZE, ZF, ZG zones
21 inlet end
22 outlet end
23 inlet fitting
24 flow bender
25 sheathing element
26 outlet fitting
27 aperture plate
28 tapering wall
29 inflow deflector
30 outflow deflector
31 aperture
31B aperture frame
32 aperture
33 tapering section
34 funnel element
42 recess
43 stick/pin, preferably containing a threaded hole
50 cover
51 flange
52 bolt connection
53 shoulder
54 bolt
61 flange
62 hole
71 flange
72 hole
81, 82 extruder screw
83 extruder flange
84 extrudate outlet
85 extruder barrel
100 extrudate inlet
133 straight section
142 shoulder
153 recess
200 flow constrictor (such as, blocking ring)
200ᵢ (where i=1, 2, 3, 4) blocking ring
wᵢ (where i=1, 2, 3, 4) width of blocking ring 200i
d23 inlet end diameter
d32 aperture diameter
L23 adapter width
H23 adapter height
Ax cross overlapping area
CA extruder chamber outlet area
IA extrudate retarder inlet area
d34-I input cross section diameter
d34-O output cross section diameter
A34-I input cross section area
A34-O output cross section area
CD1 cooling die
CD2 cooling die
CD2-I input cross section area
CD2-O output cross section area
CD3 cooling die
CD3-I input cross section area
CD3-O output cross section area

1-61. (canceled)

62. An extrudate retarder for high-moisture protein texturization extrusion, comprising:
an inlet end as inlet for receiving a flow of a melt extrudate from an extruder;
an outlet end as outlet for the flow of the melt extrudate to a cooling die; and
a flow conduit for the flow of the melt extrudate and in flow connection between the inlet end and the outlet end; and
wherein the flow conduit extends through a flow bender and an aperture plate located between the inlet end and the outlet end; and
wherein the flow bender comprises:
a first aperture arranged in an aperture frame, that is plate-like or slab-like,
the first aperture comprising channels formed in a ring-like cross-section having a circular ring section comprising at least 300°,
wherein the flow bender is configured:
to change flow direction of the flow of the melt extrudate to a centrifugal flow or substantially radially outwards directed flow to the ring-like cross-section such that the flow continues through the first aperture to have separated streams of the melt extrudate along the ring-like cross-section, and
then further in the flow direction to turn the flow of the melt extrudate to a centripetal flow or substantially radially inwards directed flow to join the separated streams to a uniform flow having an essentially circular cross-section, whereby the joining is carried out through a second aperture arranged in the aperture plate.

63. The extrudate retarder according to claim 62, wherein the extrudate retarder further comprises an inlet fitting, wherein the inlet end is arranged in the inlet fitting configured to fit with an extrudate outlet of the extruder.

64. The extrudate retarder according to claim 62, wherein the first aperture has channels having a first cross-section area, and the second aperture has channels having a second cross-section area, which is larger than the first cross-section area; and/or the ratio of total area of all channels of the first aperture to the area of extruder barrel cross-section is between 12% and 25%.

65. The extrudate retarder according to claim 64, wherein the first cross-section area is in the range of 3.46 mm²-7.07 mm², and the second cross-section area is selected from the range of 7 mm²-17 mm² such that it is larger than the first cross-section area; and/or the ratio of total area of all channels at the second aperture to the area of extruder barrel cross-section is between 9% and 14%.

66. The extrudate retarder according to claim 62, wherein the first and second apertures are separated from each other by a gap between 5 and 12 mm.

67. The extrudate retarder according to claim 62, wherein the extrudate retarder further comprises a funnel element comprising a tapering section that is located in the flow direction downwards from the aperture plate, forming a funnel defining a flow channel such that the cross-section of the flow channel gets narrower in the direction of the flow of the melt extrudate.

68. The extrudate retarder according to claim 62, wherein the extrudate retarder further comprises a sheathing element having an outlet fitting, wherein the outlet end is arranged in the outlet fitting configured to fit with an extrudate inlet of the cooling die, and the flow bender is held in place between the inlet fitting and the sheathing element.

69. The extrudate retarder according to claim 68, wherein the sheathing element comprises a recess for receiving a funnel element, wherein the funnel element, when in place, lays flat with the aperture plate to prevent flow of the melt extrudate from entering the space between the aperture plate and funnel element outside of the second aperture.

70. The extrudate retarder according to claim 68, wherein the sheathing element comprises a recess for receiving the aperture plate and having at least one shoulder to support the aperture plate.

71. The extrudate retarder according to claim 70, wherein when the flow bender is with the aperture plate, they are dimensioned so that orifices or openings in the first aperture are substantially not overlapping with orifices or openings in the second aperture.

72. The extrudate retarder according to claim 62, wherein the flow bender comprises an inflow deflector and an outflow deflector that are on opposite faces of the flow bender, the ring-like cross-section radially surrounds the inflow deflector and the outflow deflector, and wherein the first aperture has a thickness that is less than combined maximum thickness of the thickness of the flow bender measured at the position of the inflow deflector and the outflow deflector.

73. The extrudate retarder according to claim 72, wherein the inflow deflector or the outflow deflector, or both, comprise a conical structure configured to cause U turn or L turn of the flow conduit limiting to the first aperture.

74. The extrudate retarder according to claim 62, wherein the inlet fitting, the flow bender and the aperture plate comprise form-locking means.

75. The extrudate retarder according to claim 62, wherein a flow constrictor is arranged on at least one side of the flow bender to at least partially cover the first aperture.

76. The extrudate retarder according to claim 75, wherein the flow constrictor comprises a first blocking ring and a second blocking ring arranged on opposite sides of the flow bender, partially blocking the aperture in the flow bender.

77. The extrudate retarder according to claim 62, wherein the extrudate retarder is connected to the extruder via a cover of the extrudate retarder with a number of bolt connections, the cover holding the flow bender in place.

78. The extrudate retarder according to claim 62, wherein the extrudate retarder or the flow bender is designed to cause a restriction of the cross-section of the flow conduit, from an extruder outlet cross-sectional area to input cross-section area, such that ratio between input cross-section area and extruder chamber outlet area is between 12% and 40%.

79. The extrudate retarder according to claim 62, wherein the extrudate retarder or the flow bender is designed to cause a restriction of the cross-section of the flow conduit, such that ratio between input cross-section area to extrudate retarder inlet area is between 30% and 80%.

80. The extrudate retarder according to claim 62, wherein each aperture has as the distance between an entrance and an exit of a channel between 4 mm and 60 mm.

81. A method of performing high-moisture protein texturization extrusion with an extruder having a cooling die to manufacture meat-replacement products, wherein: the method comprises providing the extrudate retarder according to claim 62 between an extrudate outlet of the extruder and an extrudate inlet of the cooling die, and passing the melt extrudate through the flow conduit of the extrudate retarder.
